(19) United States
(12) Patent Application Publication
(10) Pub. No.: US 2013/0126800 A1
(43) Pub. Date: May 23, 2013

(54) NIOBIUM OXIDE-BASED THERMOELECTRIC COMPOSITES

(71) Applicant: Monika Backhaus-Ricoult, Horseheads, NY (US)

(72) Inventor: Monika Backhaus-Ricoult, Horseheads, NY (US)

(21) Appl. No.: 13/298,633

(22) Filed: Nov. 17, 2011

(51) Int. Cl. H01B 1/02; H01B 1/00

(52) U.S. Cl. 252/515; 252/519.1; 252/512; 252/519.12; 252/516

(57) ABSTRACT

A thermoelectric oxide material having at least one family of periodic planar crystallographic defects, where the planar defect interspacings match a significant fraction of the phonon dispersion (free path distribution) in the oxide material. As an example, a sub-stoichiometric, composite thermoelectric oxide material can be represented by the formula NbO_{2.5-x}:M, where 0<x≦1.5 and M represents a second phase. Optionally, the material may be doped. The thermoelectric material displays a thermoelectric figure of merit (ZT) of 0.15 or higher at 1050K. Methods of forming the thermoelectric materials involve combining and reacting raw materials under reducing conditions to form the sub-stoichiometric oxide composite. The second phase may promote reduction of the oxide. The reaction product can be sintered to form a dense thermoelectric material.

### BACKGROUND

The present disclosure relates to thermoelectric materials that can be used in thermoelectric modules or devices for electric power generation, and more particularly to niobium oxide-based composites that have a high thermoelectric figure of merit.

Thermoelectric materials can be used to generate electricity when exposed to a temperature gradient according to the thermoelectric effect. Notably, a thermoelectric device such as a thermoelectric power generator (TEG) can be used to produce electrical energy, and advantageously can operate using waste heat such as industrial waste heat generated in chemical reactors, incineration plants, iron and steel melting furnaces, and in automotive exhaust. Efficient thermoelectric devices can recover 10% or more of the heat energy from such systems, though due to the “green” nature of the energy, lower efficiencies are also of interest. Compared to other power generation approaches, thermoelectric power generators operate without toxic gas emission, and with longer lifetimes and lower operating and maintenance costs.

The conversion of thermal energy into electrical energy in thermoelectric generators is based on the Seebeck effect. If a semiconductor material is exposed to a temperature gradient, the temperature dependency of its carrier concentration produces a potential difference across the material that is proportional to the temperature difference. The Seebeck voltage, ΔU, also referred to as the thermopower or thermoelectric power of a material, is the thermoelectric voltage associated with such a temperature gradient. The Seebeck coefficient S is defined as the limit of that voltage difference when the temperature gradient goes to zero, and has units of VK⁻¹, though typical values are in the range of microvolts per Kelvin. A schematic illustration of the Seebeck effect and the associated Seebeck voltage is shown in FIG. 1. A thermoelectric couple comprises an assembly of n-type and p-type elements, which are composed respectively of n-type and p-type semiconducting materials. In a typical module, alternating n-type and p-type elements are electrically connected in series and thermally connected in parallel between electrically insulating but thermally conducting plates. A schematic illustration of a representative p/n couple and TE module are also shown in FIG. 1.

As noted above, the equilibrium carrier concentration in a semiconductor is dependant on temperature, and thus a temperature gradient in the material causes carrier migration. The motion of charge carriers in a device comprising n-type and p-type elements will create an electric current, which can be used to deliver electric power.

Suitable thermoelectric materials produce a large thermopower (potential difference across the sample) when exposed to a temperature gradient. They typically exhibit a strong dependency of their carrier concentration on temperature, have high carrier density, high carrier mobility and a low thermal conductivity. Pure p-type materials have only positive mobile charge carriers, electron holes, and a positive Seebeck coefficient, while pure n-type materials have only negative mobile charge carriers, electrons, and a negative Seebeck coefficient. Most real materials have both positive and negative charge-carriers and may also have ionic charge carriers. The sign of the Seebeck coefficient depends on the predominant carrier.

The maximum efficiency of a thermoelectric material depends on the amount of heat energy provided and on materials properties such as the Seebeck coefficient, electrical conductivity and thermal conductivity. A figure of merit, ZT, can be used to evaluate the quality of thermoelectric materials. ZT is a dimensionless quantity that for small temperature differences is defined by ZT=σS ²T/κ, where a is the electric conductivity, S is the Seebeck coefficient, T is temperature, and κ is the thermal conductivity of the material. Another indicator of thermoelectric material quality is the power factor, PF=σS². A material with a large figure of merit will usually have a large Seebeck coefficient and a large electrical conductivity. The dependency of the Seebeck coefficient, electrical conductivity and thermal conductivity on carrier density is shown graphically in FIG. 2.

Good thermoelectric materials are typically heavily-doped semiconductors or semimetals with a carrier concentration of 10¹⁹ to 10²¹ carriers/cm³. Moreover, to ensure that the net Seebeck effect is large, there should only be a single type of carrier. Mixed n-type and p-type conduction will lead to opposing Seebeck effects and lower thermoelectric efficiency. In materials having a sufficiently large band gap, n-type and p-type carriers can be separated, and doping can be used to produce a dominant carrier type. Thus, good thermoelectric materials typically have band gaps large enough to have a large Seebeck coefficient, but small enough to have a sufficiently high electrical conductivity. The Seebeck coefficient and the electrical conductivity are inversely related parameters, however, where the electrical conductivity is proportional to the carrier density (n) while the Seebeck coefficient scales with 3n^{-2/3}.

Further, a good thermoelectric material advantageously has a low thermal conductivity. Thermal conductivity in such materials comes from two sources. Phonons traveling through the crystal lattice transport heat and contribute to lattice thermal conductivity, and electric carrier transport contributes to the electronic thermal conductivity.

One approach to enhancing ZT is to minimize the lattice thermal conductivity. This can be done by increasing phonon scattering, for example, by introducing heavy atoms, disorder, large unit cells, clusters, rattling atoms, grain boundaries and interfaces.

Previously commercialized thermoelectric materials include bismuth/lead telluride-and (Si, Ge)-based materials. Materials of the family (Bi,Pb)₂(Te,Se,S)₃, for example, can reach a figure of merit in the range of 1. Slightly higher values can be achieved by doping, and still higher values can be reached for quantum-confined structures. However, due to their lack of chemical stability and low melting point, the application of these materials is limited to relatively low temperatures (<450° C.), and even at such relatively low temperatures, they require protective surface coatings. Other known classes of thermoelectric materials such as clathrates, skutterudites and silicides also have limited applicability to elevated temperature operation.

In view of the foregoing, it would be advantageous to develop thermoelectric materials capable of efficient operation at elevated temperatures. More specifically, it would be advantageous to develop environmentally-friendly, high-temperature thermoelectric materials having a high figure of merit in the medium-to-high temperature range, where based on a higher Carnot efficiency the conversion efficiency of the thermoelectric generator is also improved.

### SUMMARY

These and other aspects and advantages of the invention can be achieved by a class of thermoelectric oxide materials having periodic planar crystallographic defects, wherein the planar defects have an interplanar spacing on the order of the wavelength of the phonons in the material. The planar defects can have a plane-to-plane spacing of 0.5 to 5 nm and, in embodiments, the interplanar spacing can vary within the material over a range from about 0.5 to 5 nm, while a certain disorder of the defect configuration may also create spacings at larger distances that can address the larger wavelength (lower energy) lattice phonons.

As an example, niobium oxide-based materials having such planar defects can be used in thermoelectric generators for high temperature heat conversion to electrical power. These niobium oxides or their composites have a high Seebeck coefficient, high electrical conductivity and notably low thermal conductivity, which can be achieved in non-stoichiometric, defective structures.

Niobium oxide-based composites offer an alternative to SrTiO₃ and TiO₂-based materials. They reach their best performance at higher electrical conductivity and lower thermal conductivity and thus offer a different set of Seebeck coefficient - electrical conductivity - thermal conductivity characteristics for applications in a TEG or for pairing with a precise p-type material.

In particular, niobium oxide-based materials offer an operational advantage for TEGs due to their substantially lower thermal conductivity. For the same material ZT, a higher power output (energy conversion) can be reached in a TEG for materials with lower thermal conductivity. Thus the niobium oxides, despite their lower material ZT, may be able to produce comparable or even higher power output. Thermal conductivities of n-type niobium oxides seem to pair well with known p-type oxide materials such as cobaltites and thus encourage their combined use in thermoelectric generators.

The niobium oxide stoichiometry can range from NbO_{2.5} to NbO₂. Over this range, the oxide displays lattice conductivities of 3 W/mK and less. In achieving such low lattice conductivities in example defective oxides, applicants have discovered that, for example, crystallographic shear defects and complex block structures can provide a new approach for tuning the thermal conductivity in oxides with phonon scattering lengths at the 0.5-5 nanometer length scale. The ZT values (measured at 1000K) were as high as 0.21. For example, a thermoelectric figure of merit for the material at 1050K can be greater than 0.15, and the Seebeck coefficient at 1050K can be more negative than −80 μV/K. The lattice thermal conductivity of the material over a temperature range of 450 to 1050K can be less than 3 W/mK, and the electrical conductivity of the material over a temperature range of 450 to 1050K can be greater than 20000 S/m.

Niobium oxide-based materials can be represented by the formula NbO_{2.5-x}:M, where 0<x≦1.5 (e.g., 0.3≦x≦0.7) and M represents a second phase, and can be prepared via reduction at elevated temperature by exposure to a reducing gas such as a low oxygen partial pressure gas, CO/CO₂ mixtures, H₂/H₂O mixtures, or other reducing gas mixtures. In embodiments, the reduction can further involve a reducing environment such as carbon, or a reducing agent such as carbon, Nb, W, Mo, NbO, TiO₂, TiC, TiN, NbC, ZnO, Cu, and WC that can be optionally incorporated into the oxide as a second phase. By way of example, a starting niobium oxide powder or composite can be prepared and then densified under high pressure by heating the powder in a reducing environment (e.g., low oxygen partial pressure in a C/CO buffer environment). A complimentary reduction approach involves incorporating into the niobium oxide powder a reducing agent such as nano-sized titanium carbide (TiC) particles, which are then heated and reacted to produce a partially-reduced oxide thermoelectric material. The example partially-reduced oxide thermoelectric material comprises a solid solution of niobium-titanium oxides with a second phase solid solution of mixed titanium-niobium carbide. The resulting material can be sintered into dense elements using, for example, spark plasma sintering. The disclosed niobium oxide-based materials can be cut to shape and incorporated into a thermoelectric module or device.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

### BRIEF DESCRIPTION OF THE DRAWINGS

FIG. 1 is a schematic illustration of the Seebeck effect and shows an example p/n couple and thermoelectric module;

FIG. 2 shows the dependency on carrier concentration of the Seebeck coefficient, electrical conductivity and thermal conductivity;

FIG. 3 is a schematic of a niobium oxide block structure;

FIG. 4 is a graph of electrical conductivity versus temperature for commercially-available niobium oxide materials;

FIG. 5 is a graph of Seebeck coefficient versus temperature for commercially-available niobium oxide materials;

FIG. 6 is a graph of lattice conductivity versus temperature for commercially-available niobium oxide materials;

FIG. 7 is a graph of ZT versus temperature for commercially-available niobium oxide materials;

FIGS. 8A-8C are SEM micrographs for example niobium oxide materials;

FIG. 9 is a graph of electrical conductivity versus temperature for example niobium oxide materials;

FIG. 10 is a graph of Seebeck coefficient versus temperature for example niobium oxide materials;

FIG. 11 is a graph of lattice conductivity versus temperature for example niobium oxide materials;

FIG. 12 is a graph of ZT versus temperature for example niobium oxide materials;

FIG. 13 is a graph of electrical conductivity versus temperature for example niobium oxide-carbide composite materials;

FIG. 14 is a graph of Seebeck coefficient versus temperature for example niobium oxide-carbide composite materials;

FIG. 15 is a graph of lattice conductivity versus temperature for example niobium oxide-carbide composite materials;

FIG. 16 is a graph of ZT versus temperature for example niobium oxide-carbide composite materials;

FIG. 17 is a graph of electrical conductivity versus temperature for example niobium oxide-nitride composite materials;

FIG. 18 is a graph of Seebeck coefficient versus temperature for example niobium oxide-nitride composite materials;

FIG. 19 is a graph of lattice conductivity versus temperature for example niobium oxide-nitride composite materials;

FIG. 20 is a graph of ZT versus temperature for example niobium oxide-nitride composite materials;

FIG. 21 is a plot of Seebeck coefficient as function of electrical conductivity at about 1000K for different niobium oxide-containing materials;

FIG. 22 is a plot of lattice thermal conductivity as function of power factor at about 1000K for various niobium oxide-containing materials;

FIG. 23 is an SEM micrograph of a niobium oxide-titanium nitride composite material;

FIG. 24 is an SEM micrograph of a niobium oxide-titanium carbide composite material;

FIG. 25 is an SEM micrograph of a niobium oxide-tungsten oxide-titanium nitride composite material; and

FIG. 26 is an SEM micrograph of a niobium oxide-tungsten oxide-titanium carbide composite material.

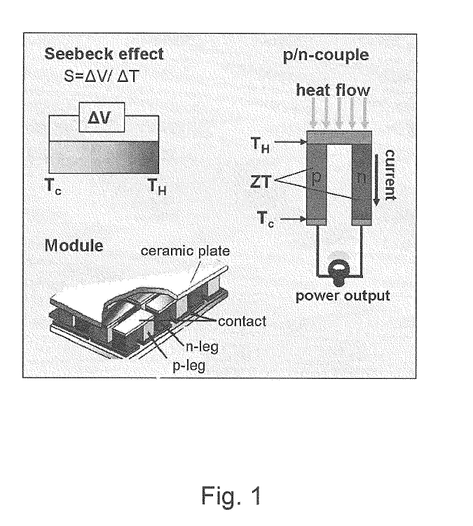

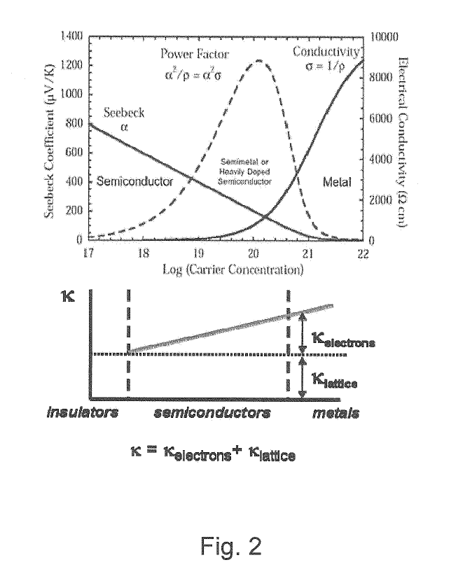

### DETAILED DESCRIPTION

The development of efficient thermoelectric generators depends fundamentally on the availability of thermoelectric materials with an enhanced figure of merit. Promising materials include those that behave as a phonon glass and/or an electron crystal. Efforts to develop high ZT materials include those that focus on improving the power factor while preserving (or even decreasing) the thermal conductivity, and those that focus on decreasing the thermal conductivity while preserving or even increasing the power factor. Even though the power factor and the thermal conductivity are strongly coupled, this general classification assists in organizing various experimental approaches.

Research efforts focused on increasing the power factor include (i) increasing the charge carrier concentration through doping, (ii) carrier pocket engineering, which involves the anisotropic distribution of carriers in a material and the use of the resulting carrier pockets to engineer an optimized thermoelectric property, (iii) resonance effects, which produce an increase in the Seebeck coefficient by additional electronic states in the band structure that are introduced through an interaction of a matrix with a dopant or with second phase particles, and (iv) energy filtering, where in nanostructured materials having optimized nano-dimensions, low energy electrons can be scattered at interfacial barriers while higher energy electrons pass unaffected so that an energy filtering of the electrons takes place. For certain combinations of nano-dimension and electron energy, the electron density distribution can be narrowed by the selective scatting, which can increase the Seebeck coefficient.

It has been recognized that the introduction of nanoscale features can alter the density of electronic states and can cause a quantum confinement effect. The induced discontinuity of the electric properties can lead to a decoupling of the Seebeck coefficient, electrical conductivity and thermal conductivity, and in special configurations result in an increase in the figure of merit.

Efforts focused on decreasing the thermal conductivity generally involve enhancing phonon scattering within the material, and include (i) the use of amorphous materials or glasses (which typically do not possess the required electrical properties), (ii) alloy scattering, which involves the introduction of homovalent and heterovalent dopant atoms in the crystal lattice to produce enhanced scattering of phonons at the perturbed lattice sites, (iii) the incorporation of rattlers, which are heavy-ion species with a large vibrational amplitude, at partially-filled structural sites to provide efficient phonon scattering, e.g., in cage structures such as skutterudites and clathrates, and (iv) nanostructured monolithic materials, composites and superlattices, which comprise a large number of grain boundaries and/or interfaces that can be designed to reduce the thermal conductivity more than the electrical conductivity.

The mean free path of electrons in solid matter is in general much shorter than the mean free path of phonons. In addition, the phonons in a solid show a rather broad energy distribution with a wide low energy tail. The phonon mean free path in silicon, for example, is 200-300 nm. The tail of the phonon distribution in silicon, however, is extremely long and ranges up to tens of micrometers. Therefore, structural and mass perturbations at length scales ranging from 10 nm to micrometers that are created in silicon produce strong phonon scattering, but do not strongly impact the electrons (at least for large wavelengths). Besides silicon, very few materials exhibit similarly large phonon mean free paths and broad distributions. Oxide materials, for example, have a phonon mean free path that is in the range of a few nanometers and thus much smaller than that of silicon. In such materials, the incorporation of nanostructuration with extremely small grain sizes can be used to introduce efficient scattering. Because it is very difficult to make dense ceramics with grain sizes on the order of 10 nm or less, however, a simple nanoceramic approach or even a nano-dispersion approach in an oxide composite is difficult to realize.

As disclosed herein, structuration at the scale of 0.5-5 nm can yield very efficient phonon scattering in oxide materials, which typically exhibit a mean free path on the order of a few nanometers. The existing range of phonon frequencies can be addressed by providing a plurality of scattering distances in either the material's crystal structure or microstructure. In embodiments, beneficial scattering can be induced by crystallographic planar defects present in high densities, in different crystal directions, and possessing a range of different interdefect spacings. Such planar defects may include crystallographic shear planes and microtwins.

A crystallographic shear plane is a planar defect that changes the anion to cation ratio within a crystalline material without substantially changing the anion coordination polyhedra of the metal ions. The metal ion coordination is usually six so that the coordination polyhedron is arranged as an octahedron of oxygen ions. The oxygen ions are linked by corners, or edges and corners, and manifest in an open structure with large open spaces. During oxygen loss in a reduction process either by direct removal of oxygen or by reaction with lower valence compounds, the octahedral network collapses along a crystallographic shear plane to produce a lower energy structure in which a complete plane of oxygen ions is missing. The non-stoichiometry is varied over a wide range with the frequency of the crystallographic oxygen shear plane in the structure forming a homologous series of defined compounds.

Crystallographic shear defects can form in several transition metal oxides including WO₃, MoO₃, Nb₂O₅, and the rutile form of TiO₂ or its combination with vanadium, chromium or other oxides. The shear defects can also form in n-type sub-stoichiometric oxides with a reduced oxygen-to-metal ratio.

Materials that can undergo simultaneously shear on different planes and form different types of intersecting shear defects can produce a block structure. For example, niobium oxides form such block structures with compositions ranging from NbO_{2.5} to NbO₂₊ₓ. In examples, two intersecting sets of crystallographic shear planes organize the material into columns of corner-shared octahedra. The columns are extended in one direction, but form block-type building blocks in a distinct direction. The size of the blocks can vary. Further, chemical substitution can change the block size. Titanium substitution, for example, introduces smaller sized blocks and pushes the stoichiometry towards (Nb,Ti)O₂. Tungsten substitution introduces larger size blocks and pushes stoichiometry towards (Nb,W)O₃.

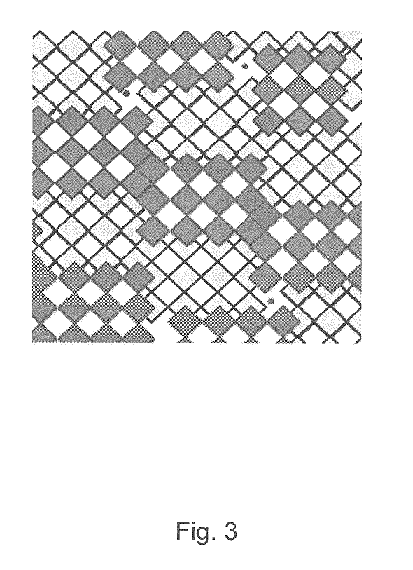

A projected-view schematic of a complex (3×4, 3×5, 3×3) niobium oxide block structure comprising edge-shared NbO₆ octahedra is shown in FIG. 3. Individual ions can fill interblock gaps. An irregular block-structured material comprises a large range of different defect interdistances that can match a wide range of corresponding phonon energies, which can provide a strong scattering of those phonons and result in a low lattice thermal conductivity. In particular, a defect plane interspacing of 1-2 nm provides an excellent match to the main phonon energies and is therefore very efficient.

In FIG. 3, each square represents a full NbO₆ octahedron with niobium at the center and symmetrically surrounded by six oxygen ions. Different bonding possibilities are possible for these octahedra. Octahedra can be bonded via corner-sharing, which is represented as corner-connected squares or by edge sharing, where two octahedra have a common edge, represented as a partial overlap of two squares in the projected view. Additional isolated niobium ions in the structure are represented as black dots and fill interblock gaps.

The representative schematic is obtained by shear on different crystallographic planes and represents a typical niobium oxide block structure with 3×4, 3×5, 3×3 blocks of NbO₆ octahedra. It is noted that the niobium ions in this structure adopt different formal oxidation states and can be distinguished by their many different electron charge states and precise position in the oxygen octahedron. Such variety of charge and position of the niobium ions widens the range for potential phonon scattering in such a structure.

A comparison of high temperature lattice thermal conductivities of various oxide materials shows that typical values are in the range of about 3-20 W/mK (e.g., 3.5 W/mK for TiO₂, 4-5 W/mK for SrTiO₃, 7 W/mK for ZnO, and 20 W/mK for alumina), while Nb-oxide block structures can show lattice conductivity below 3 W/mK.

Changes in local composition accompany local rearrangements in block size and block packing. Defects consisting of isolated corner ions, clusters, or rows of different block sizes can all co-exist in these materials. Their nature and density strongly depend on the processing of the material. A wide range of different structures can be made. Rapid local oxygen loss and large local oxygen potential gradients can produce non-equilibrium structures with very high densities of defect planes. Long annealing times and equilibration of materials reduces the defect plane density to a lower value and creates more regular defect distributions and more selected interspatial distances.

In embodiments, doped niobium oxides (Nb(D)O_{2-2.5}), where D represents a dopant, can be described as having a shear structure consisting of 3×3, 3×4 and 3×5 blocks of NbO₆ octahedra that share corners with octahedra in their own block and edges with octahedra in other blocks. Individual niobium atoms in the unit cell are located on some tetrahedral sites at block junctions. In addition, stacking faults and twinning on different planes and point defects within the individual blocks can occur.

In addition to the stoichiometric phases Nb₂O₅ and NbO₂, numerous Nb₂O₅₋ₓ phases can occur: They can be summarized by a homologous series of structurally-related niobium oxide phases with a general formula Nb₃ₙ₊₁O₈ₙ₋₂, n=5, 6, 7, 8 (e.g., Nb₁₆O₃₈, Nb₁₉O₄₆, Nb₂₂O₅₄, Nb₂₅O₆₂), and by additional oxides of the formulae Nb₁₂O₂₉ (12Nb₂O₅-2O) and Nb₉₄O₂₃₂ (47Nb₂O₅-3O). Metastable phases can be constructed by mixing different compounds of the homologous series or by mixtures of those with stable compounds.

The disclosure relates to a class of thermoelectric oxide materials comprising at least one family of periodic planar crystallographic defects. In embodiments, the planar defects have an average plane-to-plane interspacing that corresponds to a range of phonon mean free paths given by the phonon energy distribution in the material. In example embodiments, the disclosure relates generally to niobium oxide-based thermoelectric materials and methods of making such materials.

The inventive materials may be doped or un-doped and optionally may comprise a second phase. In embodiments, in addition to niobium and oxygen, dopant elements such as W, Mo, Ti, Ta, Zr, Ce, La, Y and other elements can be incorporated into the disclosed thermoelectric materials where, if included, they may substitute for Nb on cationic lattice sites and/or be incorporated on interstitial sites and modify the block size in the block structure of the defective oxide. The doped niobium oxide-based thermoelectric materials may be partially reduced. According to further embodiments, materials such as titanium carbide (TiC), niobium carbide (NbC), tungsten carbide (WC), or titanium nitride (TiN) can be used to form partially-reduced niobium oxide-based thermoelectric materials comprising a second phase.

The niobium oxide can be at least partially reduced either by exposure to reducing conditions during heating, annealing or densification, reaction with a reducing second phase that is optionally incorporated into the raw materials (e.g., powders) used to form the thermoelectric material, or a combination of both. In various embodiments, the inventive thermoelectric materials are a composite comprising niobium oxide and/or its sub-stoichiometric phases and at least one second phase. Unless otherwise defined, niobium oxide (NbO₂) and its sub-stoichiometric forms are referred to herein collectively as niobium oxide.

As disclosed in further detail herein, various n-type niobium oxide-based thermoelectric materials were made comprising a main niobium oxide phase or a niobium oxide solid solution with one or more dopants or other substitutional additions. In embodiments, a second phase was incorporated into the thermoelectric material. Example second phase additions include NbO, metals such as Nb, W or Mo, carbides such as TiC, NbC, WC, nitrides such as TiN, oxides such as TiO₂, or mixed oxides. The second phase additions may operate as a reducing reactant. In embodiments, the reducing reactant is retained as a second phase in the product material. The resulting niobium oxide-based thermoelectric materials exhibit promising thermoelectric properties, including a high electrical conductivity, a high Seebeck coefficient and, in particular, a low thermal conductivity.

As disclosed hereinafter in additional detail, niobium oxide-based thermoelectric materials have been obtained by densification of powder mixtures that were synthesized according to different preparation methods. In embodiments, an average particle size of the niobium oxide powder can range from 20 nanometers to 100 micrometers.

In one example approach, partially-reduced niobium oxide powder was obtained by exposure of Nb₂O₅ powder at high temperature, typically greater than 900° C., to a reducing environment such as a reducing gas mixture (e.g., H₂/H₂O, CO/CO₂, C/CO), or by wrapping the Nb₂O₅ powder in carbon foil in an inert gas environment or vacuum at elevated temperature. In an example reaction, the partially-reduced Nb₂O₅ can be formed via the following reaction: Nb₂O₅+C→Nb₂O₅₋ₓ+CO, where 0.05≦x≦1. The preceding chemical reaction equation is generalized and needs to be balanced with the correct stoichiometric factors for a given value of x.

In a further example, partially reduced niobium oxide was obtained by mixing Nb₂O₅ with NbO or niobium metal at high temperature in a sealed container. Reduction occurs via the general disproportionation reaction: Nb₂O₅+NbO (Nb)→Nb₂O₅₋, where 0.05≦x≦1.

In a still further embodiment, partially-reduced niobium oxide was obtained by a redox reaction between Nb₂O₅ and one or more reducing agents (e.g., TiC, TiN, NbC, WC, etc.) where the niobium oxide is partially-reduced to an oxygen-deficient niobium oxide NbOₓ with 2<x<2.5. The reductant cation can optionally partially dissolve into the solid solution. Example general reactions of this type are summarized as follows: Nb₂O₅+TiC→Nb(Ti)₂O₅₋ₓ+CO and Nb₂O₅+TiN→Nb(Ti)₂O₅₋ₓ+NO and Nb₂O₅+NbC→Nb₂O₅₋ₓ+CO, where 0.05≦x≦1. The second phase can comprise up to 30 wt. % of the material (e.g., 1, 2, 5, 10, 15, 20, 25, or 30 wt. %).

As an example reducing agent, titanium carbide is a half-metal with high electrical conductivity that crystallizes in the rock salt structure, exhibits a wide range of stoichiometry and forms a complete solid solution with niobium carbide NbC. The composition of pure titanium carbide, for example, can vary over a wide stoichiometry range, TiC_{X} (0.6<x<1). The solid solution range extends over Ti_{1-y}Nb_{y}Cₓ with 0≦y≦1 and 0≦x≦0.05 at low temperature, and a potentially broader stoichiometry range at higher temperatures. According to embodiments, TiC powder with a median powder particle size of about 200 nm (e.g., ranging from 50 to 500 nm) can be used. Such a TiC powder is hereinafter referred to as nano-TiC.

Although titanium carbide, niobium carbide and their solid solutions are relatively poor thermoelectric materials, they have high electrical conductivity and their second phase particles in the composite promote fast carrier transport through this phase. The thermal conductivity of titanium carbide at room temperature is on the order of about 20 W/mK; it is also high for the solid solution carbide. Once incorporated into the composite and reduced in size through the redox reaction with the niobium oxide, the mixed carbide particles become smaller and contribute to the phonon scattering of low energy, large wavelength phonons. In embodiments, the niobium oxide powders were mixed with different levels of titanium carbide into a composite material and then simultaneously reacted and sintered at high temperature. The amount of TiC incorporated into the composite materials can range from about 3 to 20 wt. % (e.g., 12 wt. %).

In the inventive niobium oxide-titanium carbide composites, the intrinsic oxygen activity is low due to the co-existence of the oxide with the carbide. As a result, the electrical conductivity of the composite material is higher than the electrical conductivity of the oxide without any second (TiC) phase. In embodiments, the overall electrical conductivity of the composite is determined by the chemical nature of the two phases and their distribution. Both phases undergo interdiffusion through formation of an extended zone of an inhomogeneous niobium-titanium oxide solid solution and a defined zone of an inhomogeneous niobium titanium carbide solid solution. The solid solution chemistry does not only influence the electrical properties of the composite material, but also affects its lattice thermal conductivity through alloy scattering of phonons in the solid solutions. In further embodiments, addition of TiC to the niobium oxide can decrease the lattice thermal conductivity of the resulting thermoelectric composite relative to a single phase ceramic.

Inventive niobium oxide composites may include, in lieu of TiC as an active reductant during firing or high temperature densification, other carbides, such as niobium carbide or tungsten carbide. It was observed that niobium carbide exercises lower reducing power than titanium carbide and yields smaller non-stoichiometry of the niobium oxide as well as, in all explored cases, a lower figure of merit. Tungsten carbide underwent an intensive reaction with the niobium oxides during formation of mixed carbides and formation of metallic tungsten dispersions.

Further, in addition to carbides, other reductants can be used. In an embodiment TiN is used. Titanium nitride is also a half-metal with high electrical conductivity that has a wide stoichiometry range and forms a solid solution with niobium nitride NbN. According to embodiments, TiN powder with a median powder particle size smaller than 1 um is used and is herein after referred to as nano-TiN. The titanium nitride yields not only a partial reduction of the niobium oxide, but also undergoes extensive interdiffusion through formation of a mixed oxide and nitride diffusion zones. These inhomogeneous diffusion zones do not only affect the electrical properties of the composite, but they are also the origin of an enhanced decrease of the lattice conductivity compared to the monophase material due to alloy scattering in both solid solutions. Example results reflect the highest figure of merit for composites formed with TiN based on an enhanced power factor and decreased lattice conductivity.

Thus, embodiments of the disclosure relate to a reduced (e.g., partially-reduced), and optionally-doped thermoelectric materials. The reduction can be accomplished with or without the use of a reducing agent. A reducing agent, such as TiC, NbC, WC, TiN, . . . , if used, has been demonstrated to yield a higher overall ZT value than that obtained following reduction without such a reducing agent.

Example compositions of niobium oxide-based thermoelectric materials are summarized in Table 1 together with the process conditions used to form them.

TABLE 1
Example niobium oxide-based thermoelectric material batch compositions and corresponding process details.

| | | | SPS | SPS | SPS | SPS | | | | |
|---|---|---|---|---|---|---|---|---|---|---|
| Sam- | | | initial | intermed. | intermed. | heating | SPS | SPS | | |
| ple | Sample | | heating rate | hold Temp | hold time | rate | top | hold time | P | |
| # | description | Batching | (C./min) | (C.) | (min) | (C./min) | T (C.) | (min) | (kN) | cooling |
| | | coarse niobium | | | | | | | | |
| | | oxide powders | | | | | | | | |
| 1 | Nb₂O₅ | micro Nb₂O₅ | 300 | 900 | 4 | 300 | 1100 | 10 | 20 | rapid cool |
| | (micro) | | | | | | | | | to 800, no |
| | | | | | | | | | | hold |
| 2 | Nb₂O₅ | micro Nb₂O₅ | 300 | 900 | 4 | 300 | 1200 | 10 | 20 | rapid cool |
| | (micro) | | | | | | | | | to 800, no |
| | | | | | | | | | | hold |
| 3 | Nb₂O₅ | micro Nb₂O₅ | 300 | 900 | 4 | 300 | 1200 | 10 | 20 | Rapid cool |
| | (micro) | | | | | | | | | to 950, HOLD |
| | | | | | | | | | | 5 min |
| 4 | Nb₂O₅ | micro Nb₂O₅ | 300 | 900 | 4 | 300 | 1200 | 10 | 20 | Rapid cool |
| | (micro) | | | | | | | | | to 950, HOLD |
| | | | | | | | | | | 5 min |
| 5 | NbO₂ | micro NbO₂ | | | | 300 | 1200 | 5 | 20 | |
| | (micro) | | | | | | | | | |
| 6 | NbO₂ | micro NbO₂ | 300 | 900 | 4 | 300 | 1200 | 5 | 20 | |
| | (micro) | | | | | | | | | |
| 7 | NbO | micro NbO | | | | 300 | 1200 | 5 | 20 | |
| | (micro) | | | | | | | | | |
| 8 | NbO | micro NbO | 300 | 900 | 4 | 300 | 1200 | 5 | 20 | |
| | (micro) | | | | | | | | | |
| | | fine niobium | | | | | | | | |
| | | oxide powders | | | | | | | | |
| 9 | NbO₂ | NbO₂ milled | | | | 300 | 1200 | 5 | 20 | |
| | (fine-) | | | | | | | | | |
| 10 | NbO₂ | NbO₂ milled | | | | 300 | 1200 | 30 | 20 | |
| | (fine-) | | | | | | | | | |
| 11 | NbO_{1.91} | NbO₂ milled + | | | | 300 | 1200 | 5 | 20 | |
| | (fine) | NbO milled = | | | | | | | | |
| | | 10:1 | | | | | | | | |
| 12 | NbO_{1.95} | NbO2 milled + | | | | 300 | 1200 | 5 | 20 | |
| | (fine) | NbO milled = | | | | | | | | |
| | | 20:1 | | | | | | | | |
| 13 | NbO_{1.5} | NbO₂ milled + | | | | 300 | 1200 | 5 | 20 | |
| | (fine) | NbO milled = | | | | | | | | |
| | | 1:1 | | | | | | | | |
| 14 | NbO_{1.99} | NbO:NbO₂ = | | | | | | | | |
| | | 1:99 Ampoule | | | | | | | | |
| | | fired @1200 C. | | | | | | | | |
| 15 | NbO_{2.03} | NbO₂:Nb₂O₅ = | | | | 300 | 1350 | 5 | 20 | |
| | | 94:6 | | | | | | | | |
| 16 | NbO_{2.1} | NbO₂:Nb₂O₅ = | | | | 300 | 1200 | 5 | 20 | |
| | | 80:20 | | | | | | | | |
| 17 | NbO_{2.2} | NbO₂:Nb₂O₅ = | | | | 300 | 1200 | 5 | 20 | |
| | | 60:40 | | | | | | | | |
| 18 | NbO_{2.42} = | NbO₂:Nb₂O₅ = | | | | 300 | 1200 | 5 | 20 | |
| | Nb₁₂O₂₉ | 1.4:8.6 | | | | | | | | |
| 19 | NbO_{2.47} = | NbO₂:Nb₂O₅ = | | | | 300 | 1200 | 5 | 20 | |
| | Nb₄₇O₁₁₆ | 0.4:9.6 | | | | | | | | |
| 20 | Nb₂O₅₋ₓ | NbO₂:Nb₂O₅ = | | | | 300 | 1200 | 5 | 20 | |
| | | 0.1:9.0 | | | | | | | | |
| | COMPOSITES | | | | | | | | | |
| | | Batches with | | | | | | | | |
| | | coarse Nb₂O₅ | | | | | | | | |
| 21 | Nb₂O₅—ZnO | Nb—Zn Oxide = | | | | 200 | 1200 | 4 | 15 | |
| | | 90:10 | | | | | | | | |
| 22 | Nb₂O₅—ZnO—TiN | Nb—ZnO—n-TiN = | 200 | 900 | 4 | 150 | 1100 | 10 | 20 | |
| | | 8.5:76.5:15 | | | | | | | | |
| 23 | Nb₂O₅—ZnO—Cu | Nb₂O₅—TiN—CuO = | | | | | 1000 | 4 | 15 | |
| | | 17.4:1.6:2.5 | | | | | | | | |
| 24 | Nb₂O₅:TiN = | Nb₂O₅:TiN = | | | | | | | | |
| | 5:1 | 5:1 | | | | | | | | |
| 25 | Nb₂O₅:TiN = | Nb₂O₅:TiN = | | | | | | | | |
| | 10:1 | 10:1 | | | | | | | | |
| 26 | Nb₂O₅:SiC = | Nb₂O₅:SiC = | | | | | | | | |
| | 10:1 | 10:1 | | | | | | | | |
| | | Batched with Jet | | | | | | | | |
| | | milled Nb2O5 | | | | | | | | |
| 27 | Nb₂O₅ (fine): | mix of fine | 300 | 900 | 4 | 300 | 1200 | 5 | 20 | |
| | TiC = 10:1 | Nb₂O₅:n-TiC = | | | | | | | | |
| | | 10:1 | | | | | | | | |
| 28 | Nb₂O₅ (fine): | mix of fine | 300 | 900 | 4 | 300 | 1200 | 5 | 20 | |
| | TiC = 7:1 | Nb₂O₅:n-TiC = | | | | | | | | |
| | | 7:1 | | | | | | | | |
| 29 | Nb₂O₅ (fine): | mix of fine | 300 | 900 | 4 | 300 | 1200 | 5 | 20 | |
| | TiC = 4:1 | Nb₂O₅ + | | | | | | | | |
| | | n-TiC = 4:1 | | | | | | | | |
| 30 | Nb₂O₅ (fine): | mix fine | 300 | 900 | 4 | 300 | 1200 | 5 | 20 | |
| | TiN = 10:1 | Nb₂O₅ + TiN = | | | | | | | | |
| | | 10:1 | | | | | | | | |
| 31 | Nb₂O₅ (fine): | mix fine | 300 | 900 | 4 | 300 | 1200 | 5 | 20 | |
| | TiN = 7:1 | Nb₂O₅ + TiN = | | | | | | | | |
| | | 7:1 | | | | | | | | |
| 32 | Nb₂O₅ (fine): | mix fine | 300 | 900 | 4 | 300 | 1200 | 5 | 20 | |
| | TiN = 4:1 | Nb₂O₅ + TiN = | | | | | | | | |
| | | 4:1 | | | | | | | | |
| 33 | Nb₂O₅ (fine): | mix of fine | 300 | 900 | 4 | 300 | 1200 | 5 | 20 | |
| | NbC = 7:1 | Nb₂O₅ + NbC = | | | | | | | | |
| | | 7:1 | | | | | | | | |
| 34 | Nb₂O₅ (fine): | mix of fine | 300 | 900 | 4 | 300 | 1200 | 5 | 20 | |
| | WC = 7:1 | Nb₂O₅ + WC = | | | | | | | | |
| | | 7:1 | | | | | | | | |
| | | Batched nano | | | | | | | | |
| | | Nb₂O₅ | | | | | | | | |
| 35 | Nano Nb₂O₅: | Nano Nb₂O₅: | 300 | 900 | 4 | 300 | 1200 | 5 | 20 | |
| | nano TiN = | nano TiN = 7:1 | | | | | | | | |
| | 7:1 | (mixed in | | | | | | | | |
| | | ultrasonicator) | | | | | | | | |
| 36 | Nano Nb₂O₅: | Nano Nb₂O₅: | 300 | 900 | 4 | 300 | 1100 | 2 | 20 | rapid cool |
| | nano TiN = | nano TiN = 7:1 | | | | | | | | to 600 and |
| | 7:1 | (mixed in | | | | | | | | then hold |
| | | ultrasonicator) | | | | | | | | |
| 37 | Nano Nb₂O₅: | Nano Nb₂O₅: | | | | | | | | |
| | nano TiN = | nano TiN = 7:1 | | | | | | | | |
| | 7:1 | (mixed in | | | | | | | | |
| | | ultrasonicator) | | | | | | | | |
| 38 | Nano Nb₂O₅: | Nano Nb₂O₅: | 300 | 900 | 4 | 300 | 1200 | 5 | 20 | |
| | nano TiN = | nano TiN = 5:1 | | | | | | | | |
| | 5:1 | (mixed in | | | | | | | | |
| | | ultrasonicator) | | | | | | | | |
| 39 | Nano Nb₂O₅: | Nano Nb₂O₅: | 300 | 900 | 0 | 300 | 1200 | 10 | 20 | |
| | nano TiN = | nano TiN = 5:1 | | | | | | | | |
| | 5:1 | (mixed in | | | | | | | | |
| | | ultrasonicator) | | | | | | | | |
| 40 | Nano Nb₂O₅: | Nano Nb₂O₅: | 300 | 900 | 4 | 300 | 1200 | 5 | 20 | |
| | nano TiN = | nano TiN = 4:1 | | | | | | | | |
| | 4:1 | (mixed in | | | | | | | | |
| | | ultrasonicator) | | | | | | | | |
| 41 | Nano Nb₂O₅: | Nano Nb₂O₅: | 300 | 900 | 0 | 300 | 1200 | 10 | 20 | |
| | nano TiN = | nano TiN = 4:1 | | | | | | | | |
| | 4:1 | (mixed in | | | | | | | | |
| | | ultrasonicator) | | | | | | | | |
| 42 | Nano Nb₂O₅: | Nano Nb₂O₅: | 300 | 900 | 4 | 300 | 1200 | 5 | 20 | |
| | nano TiN = | nano TiN = 3:1 | | | | | | | | |
| | 3:1 | (mixed in | | | | | | | | |
| | | ultrasonicator) | | | | | | | | |
| 43 | Nano Nb₂O₅: | Nano Nb₂O₅: | 300 | 900 | 4 | 300 | 1200 | 5 | 20 | |
| | nano TiC = | nano TiC = 7:1 | | | | | | | | |
| | 7:1 | (mixed in | | | | | | | | |
| | | ultrasonicator) | | | | | | | | |
| 44 | Nano Nb₂O₅: | Nano Nb₂O₅: | 300 | 900 | 4 | 300 | 1200 | 5 | 20 | |
| | nano TiC = | nano TiC = 5:1 | | | | | | | | |
| | 5:1 | (mixed in | | | | | | | | |
| | | ultrasonicator) | | | | | | | | |
| 45 | Nano Nb₂O₅: | Nano Nb₂O₅: | 300 | 900 | 4 | 300 | 1200 | 5 | 20 | |
| | nano TiC = | nano TiC = 4:1 | | | | | | | | |
| | 4:1 | (mixed in | | | | | | | | |
| | | ultrasonicator) | | | | | | | | |
| 46 | Nano Nb₂O₅: | Nano Nb₂O₅: | 300 | 900 | 4 | 300 | 1200 | 5 | 20 | |
| | nano TiC = | nano TiC = 3:1 | | | | | | | | |
| | 3:1 | (mixed in | | | | | | | | |
| | | ultrasonicator) | | | | | | | | |
| 47 | Nano Nb₂O₅: | Nano Nb₂O₅: | 300 | 900 | 4 | 300 | 1200 | 5 | 20 | |
| | nano W-oxide: | nano W-oxide: | | | | | | | | |
| | TiN = 20:2:5 | TiN = 20:2:5 | | | | | | | | |
| | | (mixed in | | | | | | | | |
| | | ultrasonicator) | | | | | | | | |
| 48 | Nano Nb₂O₅: | Nano Nb₂O₅: | 300 | 900 | 4 | 300 | 1200 | 5 | 20 | |
| | nano W-oxide: | nano W-oxide: | | | | | | | | |
| | TiN = 20:1:5 | TiN = 20:1:5 | | | | | | | | |
| | | (mixed in | | | | | | | | |
| | | ultrasonicator) | | | | | | | | |
| 49 | Nano Nb₂O₅: | Nano Nb₂O₅: | 300 | 900 | 4 | 300 | 1200 | 5 | 20 | |
| | nano W-oxide: | nano W-oxide: | | | | | | | | |
| | TiC = 20:2:5 | TiC = 20:2:5 | | | | | | | | |
| | | (mixed in | | | | | | | | |
| | | ultrasonicator) | | | | | | | | |
| 50 | Nano Nb₂O₅: | Nano Nb₂O₅: | 300 | 1200 | 2 | 300 | 600 | 10 | 20 | rapid cool |
| | nano W-oxide: | nano W-oxide: | | | | | | | | to 600 and |
| | TiC = 20:2:5 | TiC = 20:2:5 | | | | | | | | then hold |
| | | (mixed in | | | | | | | | |
| | | ultrasonicator) | | | | | | | | |
| 51 | Nano Nb₂O₅: | Nano Nb₂O₅: | 300 | 1200 | 2 | 30 | 500 | 2 | 20 | slow cool |
| | nano W-oxide: | nano W-oxide: | | | | | | | | from 1200 |
| | TiC = 20:2:5 | TiC = 20:2:5 | | | | | | | | to 500 in |
| | | (mixed in | | | | | | | | 20 min |
| | | ultrasonicator) | | | | | | | | |
| 52 | Nano Nb₂O₅: | Nano Nb₂O₅: | 300 | 900 | 4 | 300 | 1200 | 5 | 20 | |
| | nano W-oxide: | nano W-oxide: | | | | | | | | |
| | TiC = 20:1:5 | TiC = 20:1:5 | | | | | | | | |
| | | (mixed in | | | | | | | | |
| | | ultrasonicator) | | | | | | | | |
| 53 | Nano Nb₂O₅: | Nano Nb₂O₅: | 300 | 1200 | 2 | 300 | 600 | 10 | 20 | rapid cool |
| | nano W-oxide: | nano W-oxide: | | | | | | | | to 600 and |
| | TiC = 20:1:5 | TiC = 20:1:5 | | | | | | | | then hold |
| | | (mixed in | | | | | | | | |
| | | ultrasonicator) | | | | | | | | |
| 54 | Nano Nb₂O₅: | Nano Nb₂O₅: | 300 | 1200 | 2 | 30 | 500 | 2 | 20 | slow cool |
| | nano W-oxide: | nano W-oxide: | | | | | | | | from 1200 |
| | TiC = 20:1:5 | TiC = 20:1:5 | | | | | | | | to 500 in |
| | | (mixed in | | | | | | | | 20 min |
| | | ultrasonicator) | | | | | | | | |
| 55 | Nano Nb₂O₅: | Nano Nb₂O₅: | 300 | 900 | 4 | 300 | 1200 | 5 | 20 | |
| | nano W-oxide: | nano W-oxide: | | | | | | | | |
| | NbO2 =20:2:5 | NbO2 = 20:2:5 | | | | | | | | |
| | | (mixed in | | | | | | | | |
| | | ultrasonicator) | | | | | | | | |
| 56 | Nano Nb₂O₅: | Nano Nb₂O₅: | 300 | 1200 | 2 | 300 | 600 | 10 | 20 | rapid cool |
| | nano W-oxide: | nano W-oxide: | | | | | | | | to 600 and |
| | NbO₂ = 20:2:5 | NbO₂ = 20:2:5 | | | | | | | | then hold |
| | | (mixed in | | | | | | | | |
| | | ultrasonicator) | | | | | | | | |
| 57 | Nano Nb₂O₅: | Nano Nb₂O₅: | 300 | 1200 | 2 | 30 | 500 | 2 | 20 | slow cool |
| | nano W-oxide: | nano W-oxide: | | | | | | | | from 1200 |
| | NbO₂ = 20:2:5 | NbO2 = 20:2:5 | | | | | | | | to 500 in |
| | | (mixed in | | | | | | | | 20 min |
| | | ultrasonicator) | | | | | | | | |
| 58 | Nano Nb₂O₅: | Nano Nb₂O₅: | 300 | 900 | 4 | 300 | 1200 | 5 | 20 | |
| | nano W-oxide: | nano W-oxide: | | | | | | | | |
| | NbO₂ = 20:1:5 | NbO₂ = 20:1:5 | | | | | | | | |
| | | (mixed in | | | | | | | | |
| | | ultrasonicator) | | | | | | | | |
| 59 | Nano Nb₂O₅: | Nano Nb₂O₅: | 300 | 1200 | 2 | 300 | 600 | 10 | 20 | rapid cool |
| | nano W-oxide: | nano W-oxide: | | | | | | | | to 600 and |
| | NbO₂ = 20:1:5 | NbO₂ =20:1:5 | | | | | | | | then hold |
| | | (mixed in | | | | | | | | |
| | | ultrasonicator) | | | | | | | | |
| 60 | Nano Nb₂O₅: | Nano Nb₂O₅: | 300 | 1200 | 2 | 30 | 500 | 2 | 20 | slow cool |
| | nano W-oxide: | nano W-oxide: | | | | | | | | from 1200 |
| | NbO₂ = 20:1:5 | NbO₂ = 20:1:5 | | | | | | | | to 500 in |
| | | (mixed in | | | | | | | | 20 min |
| | | ultrasonicator) | | | | | | | | |
| 61 | nano | nano | | | | 300 | 1200 | 5 | 20 | |
| | Nb₂O₅:nano | Nb₂O₅:nano | | | | | | | | |
| | TiN:nano | TiN:nano W-oxide | | | | | | | | |
| | W-oxide | 20:5:0.5 | | | | | | | | |
| | 20:5:0.5 | | | | | | | | | |
| 62 | nano | nano | | | | 300 | 1200 | 5 | 20 | |
| | Nb₂O₅:nano | Nb₂O₅:nano | | | | | | | | |
| | TiN:nano | TiN:nano W-oxide | | | | | | | | |
| | W-oxide | 20:5:0.25 | | | | | | | | |
| | 20:5:0.25 | | | | | | | | | |
| 63 | nano | nano | | | | 300 | 1200 | 5 | 20 | |
| | Nb₂O₅:nano | Nb₂O₅:nano | | | | | | | | |
| | TiN:nano | TiN:nano W-oxide | | | | | | | | |
| | W-oxide | 20:7:0.5 | | | | | | | | |
| | 20:7:0.5 | | | | | | | | | |
| 64 | nano | nano | | | | 300 | 1200 | 5 | 20 | |
| | Nb₂O₅:nano | Nb₂O₅:nano | | | | | | | | |
| | TiN:nano | TiN:nano W-oxide | | | | | | | | |
| | W-oxide | 20:7:0.25 | | | | | | | | |
| | 20:7:0.25 | | | | | | | | | |
| | Mixed | | | | | | | | | |
| | Nb—Ti oxides | | | | | | | | | |
| 65 | Nano | Nano | 300 | 900 | 4 | 300 | 1200 | 5 | 20 | |
| | TiO₂:nano | TiO₂:nano | | | | | | | | |
| | Nb₂O₅:nano | Nb₂O₅:nano | | | | | | | | |
| | TiC = 3:1:1 | TiC = 3:1:1 | | | | | | | | |
| | | (mixed in | | | | | | | | |
| | | ultrasonicator) | | | | | | | | |
| 66 | Nano | Nano | 300 | 900 | 4 | 300 | 1200 | 5 | 20 | |
| | TiO₂:nano | TiO₂:nano | | | | | | | | |
| | Nb₂O₅:nano | Nb₂O₅:nano | | | | | | | | |
| | TiC = 7:1:2 | TiC = 7:1:2 | | | | | | | | |
| | | (mixed in | | | | | | | | |
| | | ultrasonicator) | | | | | | | | |
| 67 | Nano | Nano | 300 | 900 | 4 | 300 | 1200 | 5 | 20 | |
| | TiO₂:nano | TiO₂:nano | | | | | | | | |
| | Nb₂O₅:nano | Nb₂O₅:nano | | | | | | | | |
| | TiC = 5:3:2 | TiC = 5:3:2 | | | | | | | | |
| | | (mixed in | | | | | | | | |
| | | ultrasonicator) | | | | | | | | |
| 68 | Nano | Nano | 300 | 900 | 4 | 300 | 1200 | 5 | 20 | |
| | TiO₂:nano | TiO₂:nano | | | | | | | | |
| | Nb₂O₅:nano | Nb₂O₅:nano | | | | | | | | |
| | TiC = 4:4:2 | TiC = 4:4:2 | | | | | | | | |
| | | (mixed in | | | | | | | | |
| | | ultrasonicator) | | | | | | | | |

The starting niobium oxide raw material can be a coarse powder having an average grain size of larger than 10 μm, a ball-milled powder having an average grain size of about 2-10 μm, a jet-milled powder having an average grain size of about 1 μm, or one of a variety of nano-sized powders such as precursor-derived nano-sized powders, which may be obtained, for example, via hydrolysis from alcoholates (e.g., niobium isopropoxide), niobium chlorides, or other organic or inorganic compounds. As used herein, the prefix designations (c-), (f-) and (n-) may be used to designate coarse (2-10 μm), fine (about 1 μm) and nano-sized powders, respectively.

When used, microscopic powders of niobium oxide(s) and additional phases were mixed by ball milling or jet milling. Mixed nano-sized powders were obtained from niobium precursors and dopants or second phase precursors, mixed in organic solvents, and then hydrolyzed to provide a mixed powder.

Nanoscale powders of the constituent materials were typically dispersed in a liquid and mixed ultrasonically, dried and sieved. The liquid, which was typically an alcohol such as ethanol or isopropanol and optionally further contained a dispersant, promotes dispersion and homogenous mixing of the powders. All powder mixtures were dried prior to use.

The powders were densified by natural sintering or spark plasma sintering. In embodiments, a controlled environment was used during densification. For example, in embodiments, the powder mixtures were cold-pressed to pellets and sintered in air or a low oxygen partial pressure environment in a sealed ampoule at elevated temperature.

For rapid densification under an applied pressure, powder mixtures or pre-pressed pellets were placed into a graphite die, and then loaded into a Spark Plasma Sintering (SPS) apparatus where the powder mixture was heated and densified under vacuum and applied pressure using a rapid heating cycle with direct current heating. Heating cycles with maximum temperatures of about 900-1400° C. were used with heating rates of from about 450° C. to 100° C./min with an optional intermediate reduction or reaction hold of several minutes at intermediate temperatures such as 900° C., and a final hold time about 30 seconds to 10 minutes at the maximum temperature. A pressure of between about 10 to 70 MPa was applied to the powder mixture for densification. Samples were cooled rapidly from the maximum temperature to room temperature. Typical samples were disk-shaped, having a thickness in the range of about 2-3 mm and a diameter of about 20 mm.

In an alternative approach, mixtures of niobium oxide with other oxides that provided a low melting point mixture were combined in a platinum crucible, melted, homogenized and rapidly quenched. Examples are mixtures of niobium oxide with ZnO and TiC.

Optionally, after densification (or melting) samples were annealed in reducing or oxidizing atmosphere. Annealing temperatures ranged from 900° C. to 1200° C., and annealing times ranged from about 10 to 100 hours.

Due in part to their high figure of merit, high thermal shock resistance, thermal and chemical stability and relatively low cost, the disclosed thermoelectric materials can be used effectively and efficiently in a variety of applications, including automotive exhaust heat recovery. Though heat recovery in automotive applications involves temperatures in the range of about 400-750° C., the thermoelectric materials can withstand chemical decomposition in non-oxidizing environments or, with a protective coating, in oxidizing environments up to temperatures of 1000° C. or higher.

As disclosed herein, a method of making a thermoelectric material comprises mixing suitable starting materials, optionally heat treating or processing the starting materials at high temperature (greater than 900° C.) in air, and then heat treating the mixture in a reducing environment. In embodiments, niobium oxide starting materials (optionally including a reducing agent such as TiC, NbC, WC, TiN or others) are prepared by turbular mixing, pressing the mixed materials into a die, and heating in a sealed ampoule in a low oxygen partial pressure environment. In one embodiment, the powder is cold pressed in a 20 mm die at about 4000 psi in a uniaxial press, following by annealing at low oxygen partial pressure at 1200° C. for 8 hours and the placed in a graphite die for hot pressing. In another embodiment the composite powders are cold pressed and directly placed in the graphite die for hot pressing. In still another embodiment the powders are directly filled in the die for hot pressing

The prepared powders can be densified using spark plasma sintering (SPS). In an example method, a powder mixture or cold pressed pellet can be placed into a graphite die, which is loaded into a Spark Plasma Sintering (SPS) apparatus where the powder mixture is heated and densified under vacuum and under applied pressure using a rapid heating cycle. Spark Plasma Sintering is also referred to as the Field Assisted Sintering Technique (FAST) or Pulsed Electric Current Sintering (PECS). Other types of sintering can be used, such as HP or natural sintering in a reducing environment. Of course, other types of apparatus can be used to mix and compact the powder mixture. For example, powders can be mixed using ball milling or spray drying. Compaction of the mixture may be accomplished using a uniaxial or isostatic press.

Physical and thermoelectric properties, including sample density (dens.), percentage of theoretical density (% dens.), phase(s) present in XRD (phase), and the Seebeck coefficient (S), electrical conductivity (EC), thermal conductivity (TC) and lattice thermal conductivity (LTC) measured at 750K and 1000K are summarized in Table 2 for the samples listed in Table 1.

The total thermal conductivity is a sum of lattice and electronic conductivity, x=x_{lattice}+X_{electrons}, and can be derived through application of the Franz Wiedemann law, X_{electrons}σT K, where σ is the electrical conductivity, T is temperature, and K is the Lorenz constant for which the value from free electrons is assumed. Table 2 also shows values for the figure of merit (ZT) at 750K and 1000K. In Table 2, density data (dens.) are reported in units of g/cm³ (dens), Seebeck coefficient in microvolts/Kelvin, electrical conductivity in S/m, and the thermal conductivity and lattice thermal conductivity in W/mK.

TABLE 2
Physical and thermoelectric data for niobium oxide-based materials

| Sample | | % | | S | S | EC | EC | TC | TC | LTC | LTC | ZT | ZT |
|---|---|---|---|---|---|---|---|---|---|---|---|---|---|
| # | dens. | dens. | phase | 750 | 1000 | 750 | 1000 | 750 | 1000 | 750 | 1000 | 750 | 1000 |
| 1 | | | Nb₂O₅ | | | | | 2.10 | 2.01 | | | | |
| 2 | | | Nb₂O₅ | −244 | −275 | 1240 | 1390 | 1.76 | 1.97 | 1.74 | 1.94 | 0.03 | 0.05 |
| 3 | | | Nb₂O₅ | −194 | −224 | 2440 | 2620 | 1.46 | 2.11 | 1.41 | 2.05 | 0.05 | 0.06 |
| 4 | | | Nb₂O₅ | −188 | −229 | 3738 | 3373 | | | | | | |
| 5 | 5.63 | 95 | NbO₂ + Nb₁₂O₂₉ | −159 | −139 | 3330 | 23514 | 2.19 | 2.48 | 2.12 | 1.90 | 0.03 | 0.18 |
| 6 | 5.42 | 91 | NbO₂ + Nb₁₂O₂₉ | −167 | −143 | 3020 | 22000 | 2.51 | 2.68 | 2.45 | 2.13 | 0.03 | 0.17 |
| 7 | 5.47 | 75 | NbO + NbO₂ | −10 | −25 | 178000 | 227000 | 8.60 | 8.79 | 5.29 | 3.16 | 0.00 | 0.02 |
| 8 | 5.27 | 72 | NbO + NbO₂ | −8 | −22 | 238000 | 253000 | 6.71 | 7.34 | 2.28 | 1.06 | 0.00 | 0.02 |
| 9 | 5.58 | 94 | NbO₂ + Nb₁₂O₂₉ | −180 | −137 | 3484 | 31102 | 2.79 | 3.16 | 2.73 | 2.38 | 0.03 | 0.19 |
| | | | (w) | | | | | | | | | | |
| 10 | 5.62 | 95 | NbO₂ + Nb₁₂O₂₉ | −155 | −131 | 3727 | 26912 | 2.77 | 3.09 | 2.70 | 2.43 | 0.02 | 0.15 |
| | | | (w) | | | | | | | | | | |
| 11 | 5.72 | 96 | NbO₂ + Nb₁₂O₂₉ | −207 | −133 | 3000 | 39400 | 3.06 | 3.23 | 3.00 | 2.25 | 0.03 | 0.22 |
| | | | (w) | | | | | | | | | | |
| 12 | 5.70 | 96 | NbO₂ + Nb₁₂O₂₉ | −220 | −130 | 2320 | 31100 | 2.75 | 3.15 | 2.71 | 2.37 | 0.03 | 0.17 |
| | | | (w) | | | | | | | | | | |
| 13 | 5.90 | | NbO + NbO₂ | −33 | −53 | 44700 | 140000 | | | | | | |
| 14 | 5.51 | | NbO₂ | −345 | −128 | 995 | 27698 | | | | | | |
| 15 | 5.44 | | NbO₂ + Nb₁₂O₂₉ | −135 | −135 | 5276 | 25541 | 2.21 | 2.81 | 2.11 | 2.18 | 0.03 | 0.17 |
| 16 | 5.23 | | — | −97 | −125 | 9051 | 26509 | 3.00 | 2.59 | 2.83 | 1.93 | 0.02 | 0.16 |
| 17 | 5.01 | | Nb₁₂O₂₉ | −84 | −118 | 20496 | 16999 | 2.83 | 2.87 | 2.44 | 2.45 | 0.04 | 0.08 |
| 18 | 4.59 | 100 | 2 forms of Nb₂O₅ | −82 | −110 | 15476 | 31706 | 2.43 | 2.50 | 2.14 | 1.72 | 0.03 | 0.15 |
| 19 | 4.45 | 100 | 1 form of Nb₂O₅ | −160 | −202 | 5679 | 4141 | 2.18 | 2.06 | 2.08 | 1.96 | 0.05 | 0.08 |
| 20 | 4.36 | 98 | NbO₂+ Nb₂O₅ | −186 | −235 | 3373 | 2545 | 2.00 | 1.85 | 1.93 | 1.79 | 0.04 | 0.08 |
| 21 | | | Ti₂Nb₁₀O₁₂ + | −226 | −256 | 1005 | 1210 | 1.95 | 2.03 | 1.93 | 2.00 | 0.02 | 0.04 |
| | | | ZnNb₂O₆ | | | | | | | | | | |
| 22 | | | TiNbO₂ | −154 | −121 | 2600 | 25600 | 0.98 | 2.07 | 0.93 | 1.43 | 0.05 | 0.18 |
| 23 | | | TiNbO₂ + Cu | −106 | −109 | 14700 | 28600 | 3.18 | 2.32 | 2.91 | 1.61 | 0.04 | 0.15 |
| 24 | 4.28 | | Ti₂Nb₁₀O₁₂ + | | | | | 2.25 | 2.57 | 2.25 | 2.57 | 0.00 | 0.00 |
| | | | TiNbO₄ + TiN | | | | | | | | | | |
| 25 | 4.71 | | Ti₂Nb₁₀O₁₂ + | | | | | 2.47 | 2.86 | 2.47 | 2.86 | 0.00 | 0.00 |
| | | | TiNbO₄ + TiN | | | | | | | | | | |
| 26 | 4.20 | 95 | NbO₂ + Nb₂O₅ | | | | | 2.40 | 2.67 | 2.40 | 2.67 | 0.00 | 0.00 |
| 27 | 4.85 | | (Nb,Ti)O₂, + | −125 | −109 | 19200 | 40800 | 2.90 | 3.37 | 2.54 | 2.36 | 0.08 | 0.14 |
| | | | (Ti,Nb)N | | | | | | | | | | |
| 28 | 5.13 | | (Nb,Ti)O₂, + | −138 | −109 | 25400 | 62000 | 2.92 | 4.16 | 2.45 | 2.62 | 0.12 | 0.18 |
| | | | (Ti,Nb)N | | | | | | | | | | |
| 29 | 5.20 | | (Nb,Ti)O₂, + | −125 | −112 | 28800 | 52500 | 2.91 | 3.77 | 2.37 | 2.47 | 0.12 | 0.17 |
| | | | TiC + NbC | | | | | | | | | | |
| 30 | 4.95 | | (Nb,Ti)O₂, + | −128 | −111 | 9499 | 34717 | 1.88 | 2.70 | 1.70 | 1.84 | 0.06 | 0.16 |
| | | | Ti₂Nb₁₀O₂₉ | | | | | | | | | | |
| 31 | 5.21 | | Ti₂Nb₁₀O₂₉ | −132 | −105 | 17600 | 64000 | 2.59 | 3.52 | 2.26 | 1.94 | 0.09 | 0.20 |
| 32 | 5.31 | | (Nb,Ti)O₂, + | −113 | −101 | 40698 | 83617 | 3.66 | 4.95 | 2.90 | 2.88 | 0.11 | 0.17 |
| | | | (Ti,Nb)N + TiN | | | | | | | | | | |
| 33 | 4.81 | | Nb₁₂O₂₉ + NbC | −69 | −103 | 19700 | 25900 | 3.10 | 3.38 | 2.73 | 2.74 | 0.02 | 0.08 |
| 34 | 4.75 | | Nb₆₀WO₁₅₃ + WC + | −138 | −175 | 8130 | 6170 | 2.46 | 2.22 | 2.31 | 2.07 | 0.05 | 0.09 |
| | | | NbC + (W,Nb) | | | | | | | | | | |
| 35 | 5.03 | | TiNbO₄ | −129 | −106 | 8979 | 58061 | 1.58 | 2.87 | 1.41 | 1.43 | 0.07 | 0.23 |
| 36 | | | TiNbO₄ + TiN | −123 | −101 | 22732 | 49539 | | | | | | |
| 37 | 5.00 | | TiNbO2 | | | | | 1.45 | 2.62 | | | | |
| 38 | | | TiNbO₄ + TiN + | −123 | −100 | 25304 | 76550 | 2.80 | 3.83 | 2.33 | 1.93 | 0.10 | 0.20 |
| | | | TiNbN₂ | | | | | | | | | | |
| 39 | | | TiNbO₄ + TiN + | −125 | −91 | 22672 | 69677 | 2.18 | 3.65 | 1.76 | 1.92 | 0.12 | 0.16 |
| | | | TiNbN₂ | | | | | | | | | | |
| 40 | 5.11 | | TiNbO₄ + TiNbN₂ | −124 | −99 | 26298 | 73146 | 2.85 | 3.49 | 2.36 | 1.68 | 0.11 | 0.21 |
| 41 | 5.31 | | TiNbO₄ | −122 | −93 | 26606 | 76823 | 2.72 | 3.93 | 2.23 | 2.02 | 0.11 | 0.17 |
| 42 | 5.21 | | TiNbO₄ + TiN + | −114 | −92 | 36836 | 87448 | 4.00 | 5.50 | 3.31 | 3.33 | 0.09 | 0.13 |
| | | | TiNbN₂ | | | | | | | | | | |
| 43 | 4.90 | | TiNbO₄ | −137 | −99 | 23410 | 51432 | 2.71 | 3.34 | 2.27 | 2.07 | 0.12 | 0.15 |
| 44 | 5.22 | | TiNbO₄ + NbC | | | | | 2.90 | 3.57 | | | | |
| 45 | 5.18 | | TiNbO₄ + NbC | −120 | −102 | 32918 | 58269 | 2.85 | 3.49 | 2.23 | 2.05 | 0.13 | 0.17 |
| 46 | 5.16 | | TiNbO₄ + NbC | −107 | −102 | 31220 | 49328 | 3.15 | 3.78 | 2.57 | 2.56 | 0.09 | 0.14 |
| 47 | 5.31 | | TiNbO₄ + TiN, | −110 | −95 | 37733 | 75555 | 3.08 | 3.86 | 2.38 | 1.99 | 0.11 | 0.18 |
| | | | TiNbN₂, W | | | | | | | | | | |
| 48 | 5.17 | | TiNbO₄ + TiN, | −113 | −92 | 34954 | 79944 | 3.13 | 4.22 | 2.48 | 2.24 | 0.11 | 0.16 |
| | | | TiNbN2, W | | | | | | | | | | |
| 49 | 5.23 | | TiNbO₄ + NbC + | −117 | −103 | 29149 | 50842 | 3.04 | 3.41 | 2.50 | 2.15 | 0.10 | 0.16 |
| | | | WC | | | | | | | | | | |
| 50 | 5.20 | | TiNbO₄ + TiC + | −116 | −104 | 28521 | 52499 | 2.85 | 3.25 | 2.32 | 1.95 | 0.10 | 0.17 |
| | | | WC | | | | | | | | | | |
| 51 | 5.22 | | TiNbO₄ + NbC + | −101 | −133 | 15897 | 12505 | 2.38 | 3.34 | 2.08 | 3.03 | 0.05 | 0.07 |
| | | | TiC + WC | | | | | | | | | | |
| 52 | 5.21 | | TiNbO₄ + | | | | | 2.90 | 3.70 | | | | |
| | | | (NbTi)C + WC | | | | | | | | | | |
| 53 | 5.18 | | TiNbO₄ + | −123 | −100 | 26522 | 50206 | 2.83 | 3.30 | 2.34 | 2.05 | 0.11 | 0.15 |
| | | | (NbTi)C | | | | | | | | | | |
| 54 | 5.18 | | TiNbO₄ + | −122 | −107 | 28607 | 51825 | 2.96 | 3.43 | 2.43 | 2.14 | 0.11 | 0.17 |
| | | | (NbTi)C | | | | | | | | | | |
| 55 | 4.67 | | Nb₂O₅ + W | −134 | −164 | 8530 | 7040 | 2.31 | 2.12 | 2.15 | 1.95 | 0.05 | 0.09 |
| 56 | 4.68 | | Nb₂O₅ + W | −132 | −159 | 8543 | 6920 | 2.17 | 2.02 | 2.01 | 1.85 | 0.05 | 0.09 |
| 57 | 4.69 | | Nb₂O₅ + W | −138 | −166 | 8420 | 6836 | 2.20 | 2.89 | 2.04 | 2.72 | 0.05 | 0.06 |
| 58 | 4.57 | | Nb₂O₅ + Nb₂₆W₄O₇₇ + W | −97 | −120 | 16962 | 13008 | 2.30 | 2.20 | 1.98 | 1.88 | 0.05 | 0.09 |
| 59 | 4.66 | | Nb₂O₅ + Ti2Nb₁₀O₂₉ + W | −118 | −105 | 27198 | 49210 | 2.19 | 2.30 | 1.68 | 1.08 | 0.13 | 0.24 |
| 60 | 4.67 | | Nb₂O₅ +Ti₂Nb₁₀O₂₉ + W | −103 | −135 | 14764 | 11742 | 2.32 | 2.22 | 2.05 | 1.93 | 0.05 | 0.10 |
| 61 | | | | −121 | −95 | 33808 | 66936 | | | | | | |
| 62 | 5.09 | | TixNb₂₋ₓO₄, | −120 | −94 | 32269 | 76909 | 3.56 | 4.33 | 3.40 | 2.42 | 0.10 | 0.16 |
| | | | (Ti,Nb)N, W | | | | | | | | | | |
| 63 | 4.97 | | TixNb₂₋ₓO₄, | −114 | −91 | 42120 | 88307 | 4.00 | 4.90 | 3.22 | 2.71 | 0.10 | 0.15 |
| | | | (Ti,Nb)N, W | | | | | | | | | | |
| 64 | 5.07 | | TixNb₂₋ₓO₄, | −111 | −93 | 47713 | 104570 | 4.10 | 5.00 | 3.21 | 2.41 | 0.11 | 0.18 |
| | | | (Ti,Nb)N, W | | | | | | | | | | |
| 65 | | | TiO₂, NbC, | −82 | −88 | 44414 | 41683 | 4.23 | 3.88 | 3.40 | 2.85 | 0.05 | 0.08 |
| | | | (Ti,Nb)C | | | | | | | | | | |
| 66 | | | TiO₂, Ti₄O₇, | −98 | −114 | 40162 | 36614 | 3.61 | 3.45 | 2.87 | 2.54 | 0.08 | 0.14 |
| | | | Ti₅O₉, NbC, | | | | | | | | | | |
| | | | (Ti,Nb)C | | | | | | | | | | |
| 67 | | | TiNbO₄, Ti₅O₉, | −91 | −95 | 40891 | 37812 | 3.90 | 3.90 | 3.14 | 2.96 | 0.07 | 0.09 |
| | | | NbC,(Ti,Nb)C | | | | | | | | | | |
| 68 | | | TiNbO₄, Ti₄O₇, | −91 | −105 | 45569 | 41126 | 3.94 | 3.67 | 3.09 | 2.65 | 0.07 | 0.12 |
| | | | Ti₅O₉, NbC, | | | | | | | | | | |
| | | | (Ti,Nb)C | | | | | | | | | | |

Aspects of the characterization methods used to evaluate the materials disclosed herein are summarized below. Sample densities were obtained from the ratio of weight measured on Mettler balance (precision ˜1 mg) to volume of polished 10 mm×10 mm×2 mm plates and/or 3 mm×3 mm×14 mm bars.

The phases present in powders and dense materials were identified by X-ray diffraction (XRD). A Bruker D4 diffraction system equipped with a multiple strip LynxEye high speed detector was used. High resolution spectra were typically acquired from 15 to 100° (2θ). Rietveld refinement was used to identify the various phases.

Scanning electron microscopy was conducted on fracture surfaces and on polished cross sections of densified samples. The spatial distribution of porosity and phases present at a microscopic level was qualitatively evaluated. In this regard, energy dispersive X-ray analysis with a light element detector was used to identify local sample composition.

Electrical conductivity and thermal power were measured simultaneously on a ZEM3 from ULVAC Technologies from room temperature to 800° C. The equipment was equipped with platinum electrodes. The samples were cut plan-parallel and polished top, bottom and at least on one side. The typical sample size was 12 mm×2-3 mm×2-3 mm. Samples were mounted in the ZEM between two platinum electrodes and contacted with two thermocouple contacts. Typically thin graphite foils were placed between electrodes or contacts and the sample for establishing good contact and avoiding degradation of the electrodes. Control measurements without graphite foil were also made and showed no difference in the data.

The ZEM was equipped with a gold-coated vacuum furnace to heat the chamber (and sample) to a base temperature. The base temperature was measured by a thermocouple. A micro-heater located at the bottom electrode was used to establish a controlled temperature difference across the sample. The temperature difference across the sample and the corresponding thermopower were measured with two thermocouples that were spaced approximately 6 mm apart.

In order to determine the Seebeck coefficient for a given base temperature, several temperature gradients were set up across the sample and the thermopower between the two probes was measured. Typically the temperature range was 200 to 800° C., and measurements were made at each 100° C. increment with a temperature difference of 5, 10, 15, 20K. Measurements were controlled by a computer. The Seebeck coefficient for a given base temperature was obtained by extrapolating the thermopower-temperature gradient curve to zero.

The electrical conductivity was measured over the entire sample length between the top and bottom contact electrodes. The exact distance between the electrodes was measured with an optical camera. A plot of current versus voltage was acquired at room temperature to verify that the probes and electrodes were in intimate contact with the sample. Measurements were done in a helium atmosphere with residual oxygen content of 1-5 ppm.

Thermal conductivity and specific heat measurements were performed simultaneously using the laser flash method in an ANTER 3 (Atner Corp., Pittsburg, Pa.). For these measurements, 10 mm×10 mm samples with a 2-3 mm thickness were cut, polished and coated with graphite. Three samples were placed together in a holder together with a reference sample of Pyroceram that was used to determine the heat capacity. The measurements were performed between room temperature and 1000° C. in an evacuated furnace with argon refill. The thermal conductivity was obtained at various temperatures from the product of heat capacity, sample density and thermal diffusivity.

The electrical conductivity and Seebeck coefficient can show inverse responses to parameter changes.

In embodiments, the disclosed thermoelectric materials have an electrical conductivity greater than 2000 S/m, a Seebeck coefficient (absolute value) greater than 80 μV/K, and a thermal conductivity κ over a temperature range of 450-1050K of less than 3 W/mK. By way of example, the electrical conductivity can be greater than 2×10³, 3×10³, 4×10³, 5×10³, 6×10³, 7×10³, 8×10³, 9×10³, 10⁴, 2×10⁴, 3×10⁴, 4×10⁴, 5×10⁴, 6×10⁴, 7×10⁴, 8×10⁴, 9×10⁴ or 10⁵ S/m, the value of the Seebeck coefficient can be more negative than −80, −100, −150, −200 or −250 μV/K, and the thermal conductivity over the range of 450-1050K can be less than 3, 2.5 or 2 W/mK. Further, the electrical conductivity, Seebeck coefficient and thermal conductivity may have values that extend over a range where the minimum and maximum values of the range are given by the values above. For example, a thermoelectric material that has an electrical conductivity greater than 10⁴ S/m can also be defined as having an electrical conductivity between 2×10⁴ and 10⁵ S/m.

Recalling that the power factor is defined as PF=σS², and the figure of merit is defined as ZT=σS²T/κ, according to embodiments the disclosed thermoelectric material has a power factor times temperature at 1000 K greater than about 0.1 W/mK (e.g., greater than 0.1, 0.2, 0.3, 0.4, 0.5, 0.6, 0.7, 0.8, 0.9, 1.0, 1.1, 1.2 or 1.3 W/mK) and a figure of merit at 1000K greater than about 0.15 (e.g., greater than 0.15, 0.2, or 0.25). Further, values of power factor times temperature and figure of merit may extend over a range where the minimum and maximum values of the range are given by the values above.

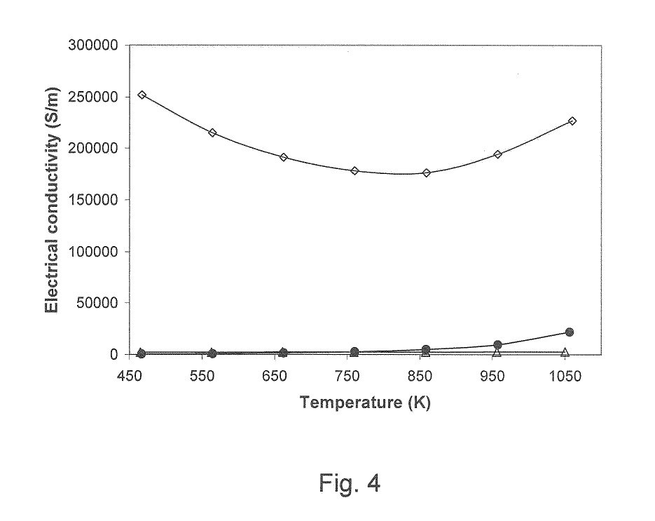

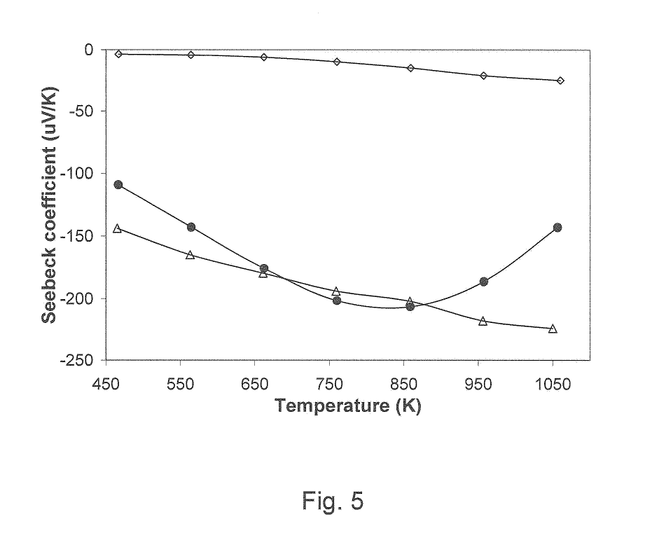

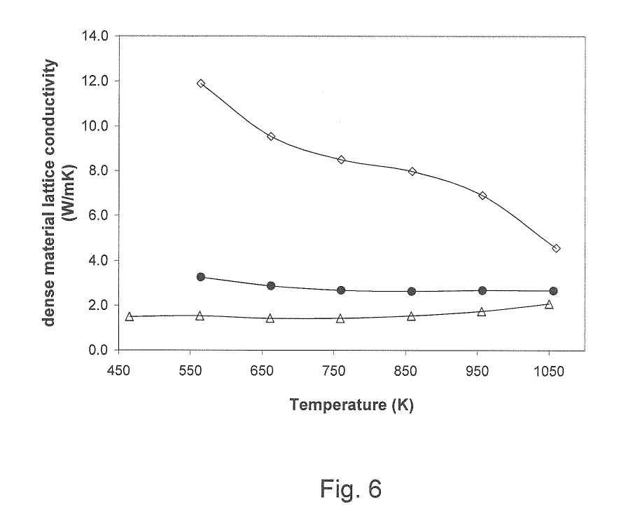

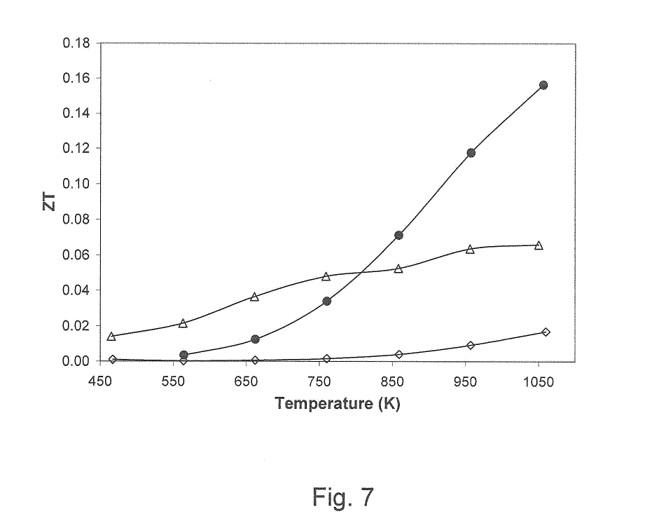

FIGS. 4-7 show comparative thermoelectric data for commercially-available niobium oxide materials. In each of FIGS. 4-7, the Nb₂O₅ is represented by open triangles, NbO₂ is represented by filled circles, and NbO is represented by open diamonds. The data show the variation as a function of temperature of the electrical conductivity (FIG. 4), the Seebeck coefficient (FIG. 5), the lattice thermal conductivity (extrapolated to dense material) (FIG. 6) and the Figure of Merit (FIG. 7).

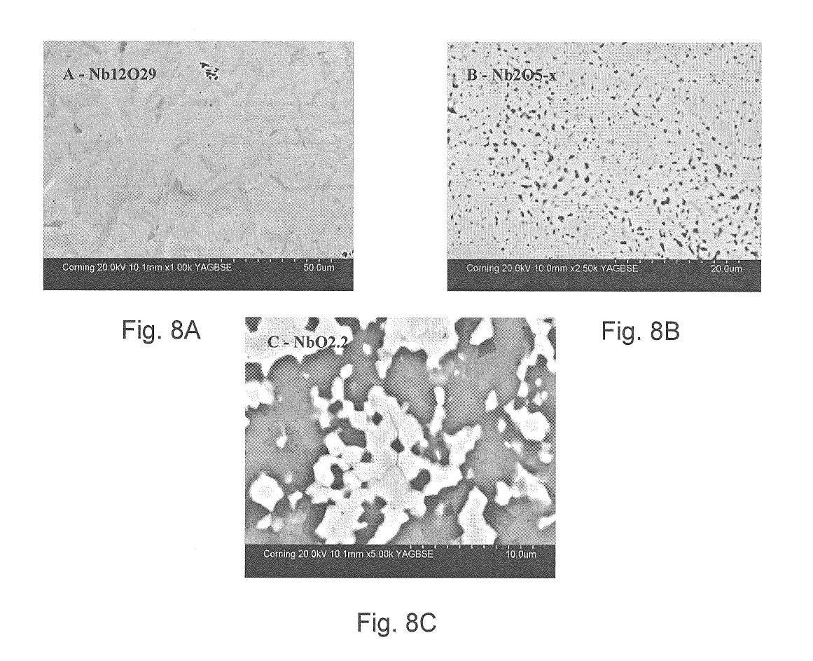

In accordance with the methods disclosed herein, dense niobium oxide materials were fabricated over a range of compositions from NbO₁₋ₓ, to Nb₂O₅₊ₓ using disproportionation reactions. Scanning electron micrographs showing the microstructure of various example niobium oxide materials are shown in FIGS. 8A-8C. The compositions of the example materials included Nb₁₂O₂₉ (FIG. 8A), Nb₂O₅₋ₓ (FIG. 8B) and NbO_{2.2} (FIG. 8C).

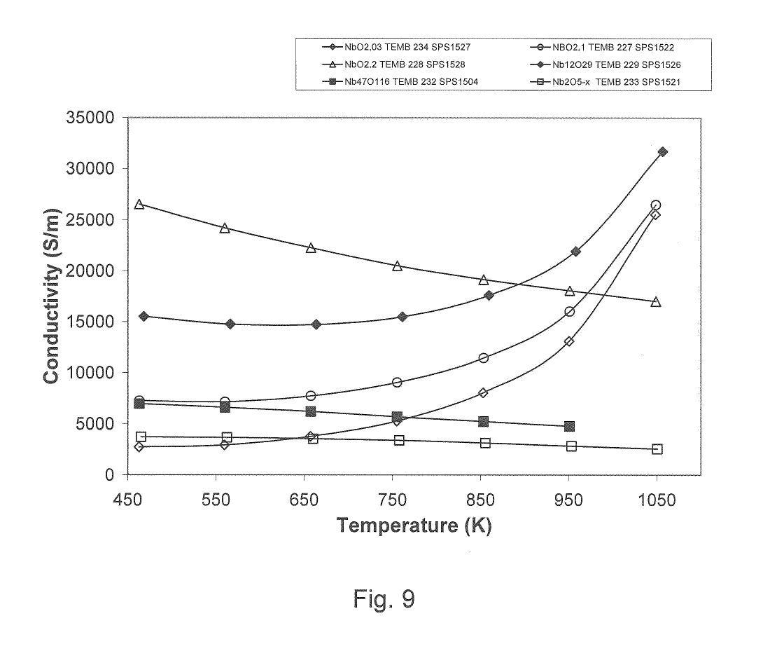

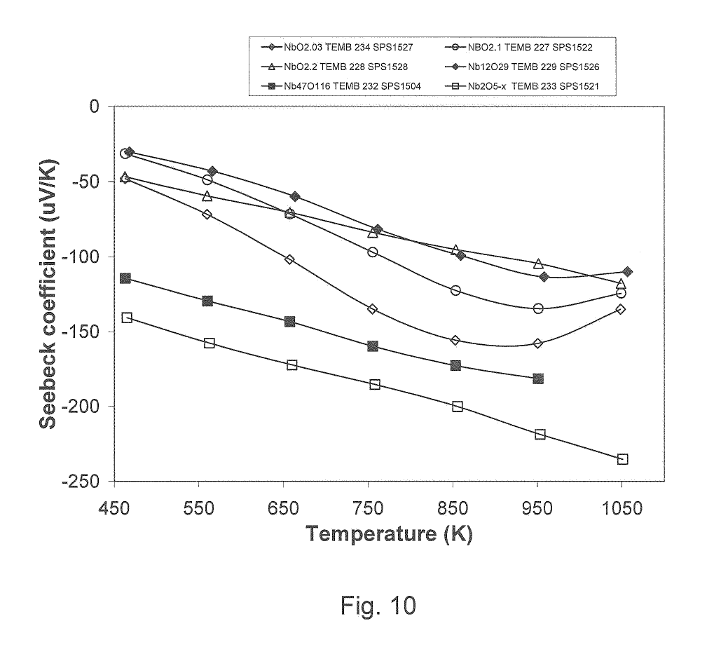

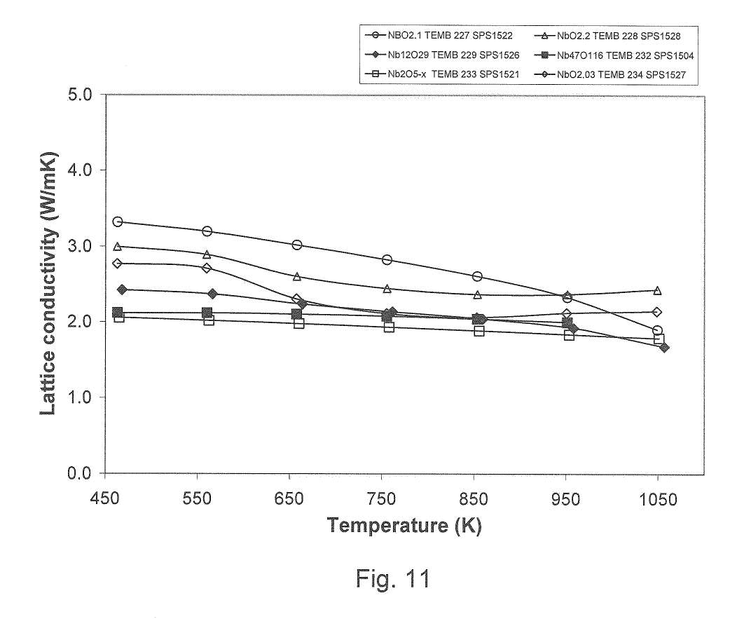

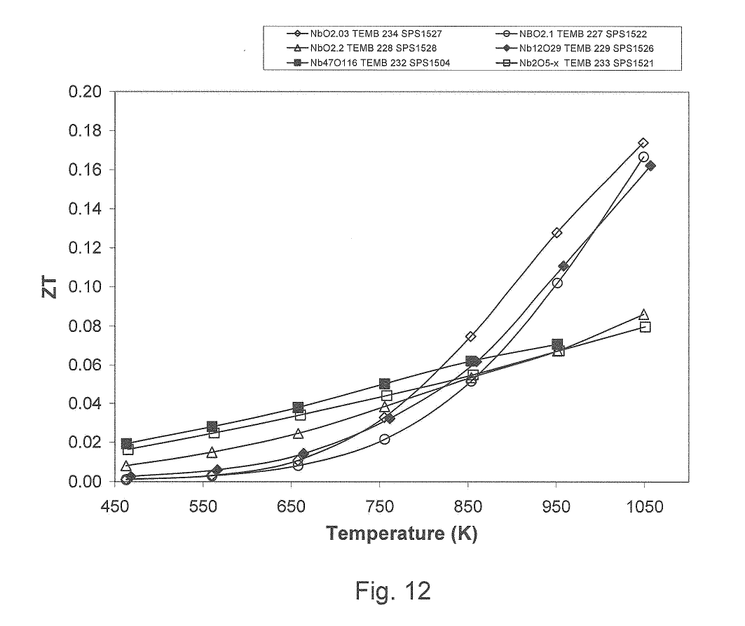

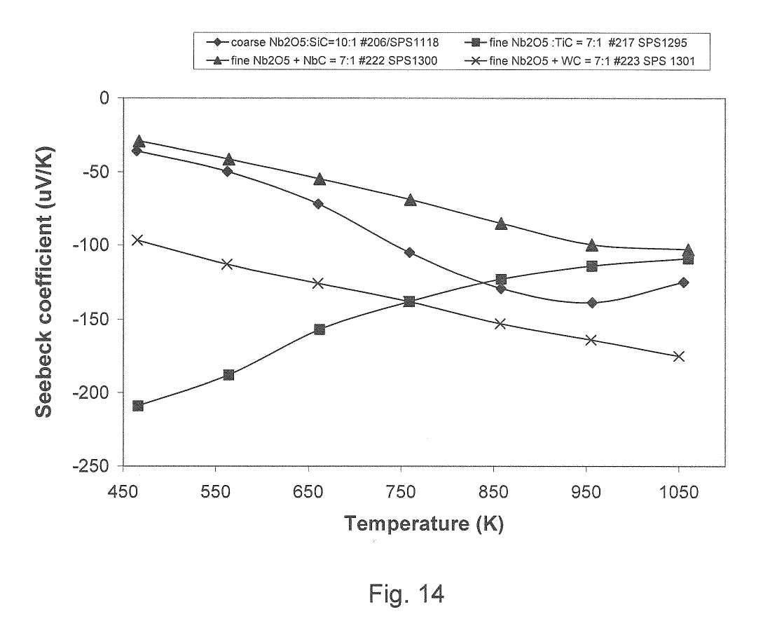

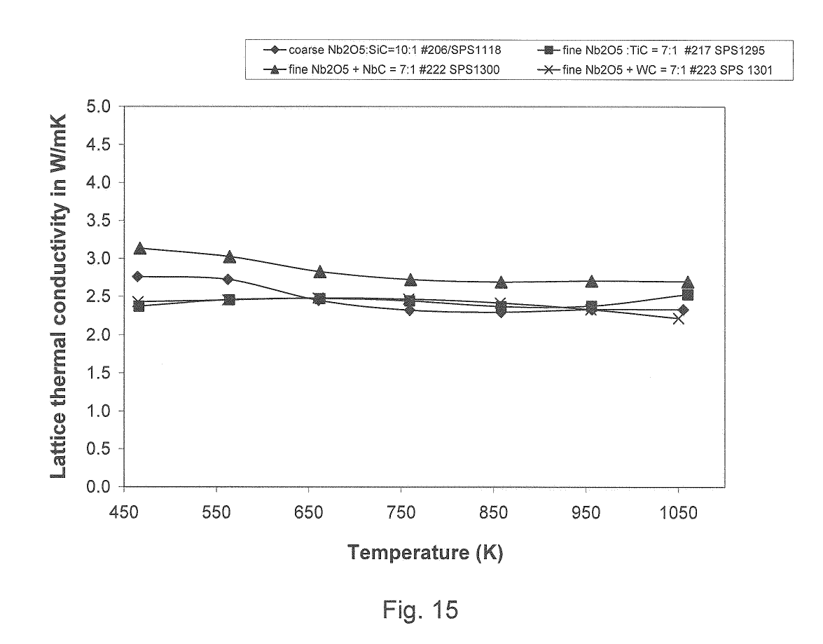

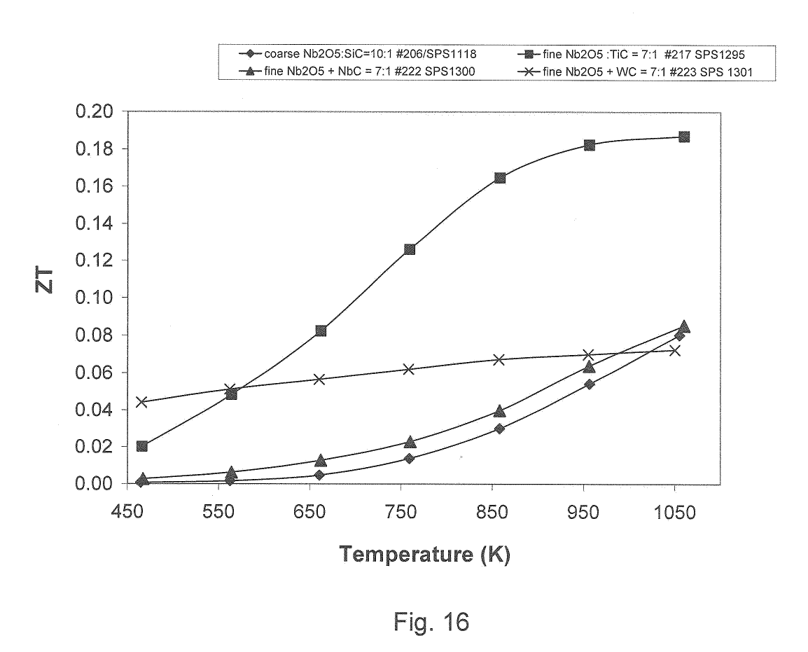

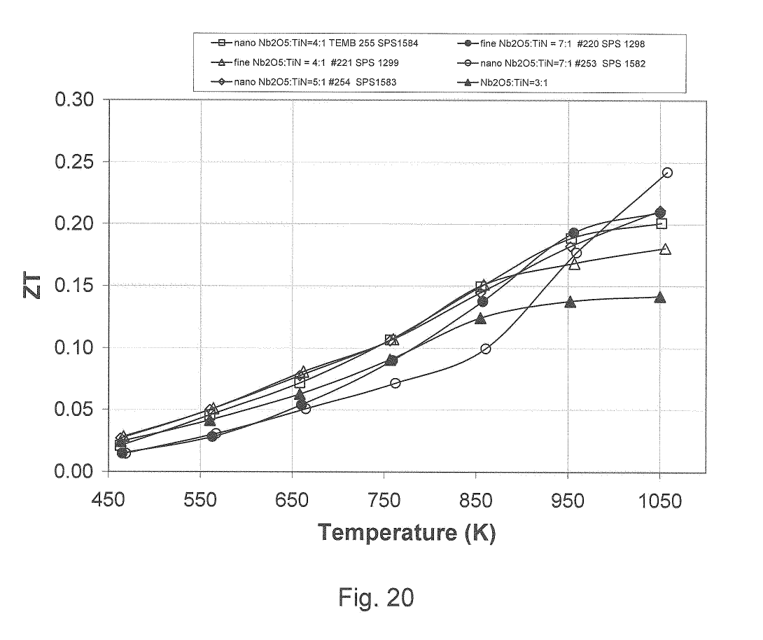

The thermoelectric properties of several example niobium oxide and niobium oxide composite materials are shown in FIGS. 9-20. Plots versus temperature of electrical conductivity, Seebeck coefficient, lattice conductivity and ZT for niobium oxide materials having different batching stoichiometries are shown in FIGS. 9-12, respectively. A key identifying the various compositions is shown in the inset. In the respective keys, the TEMB designation is a sample reference number, and the SPS designation refers to a sintering (SPS) protocol.

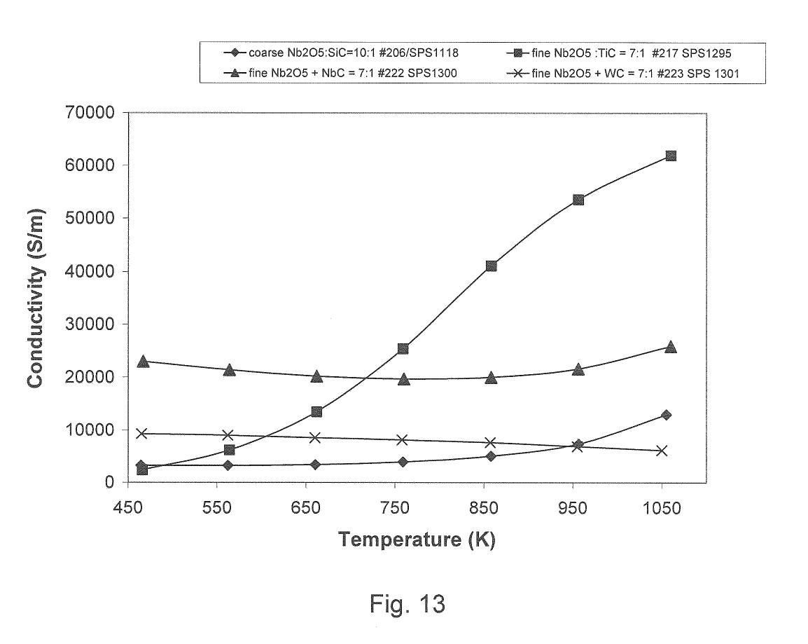

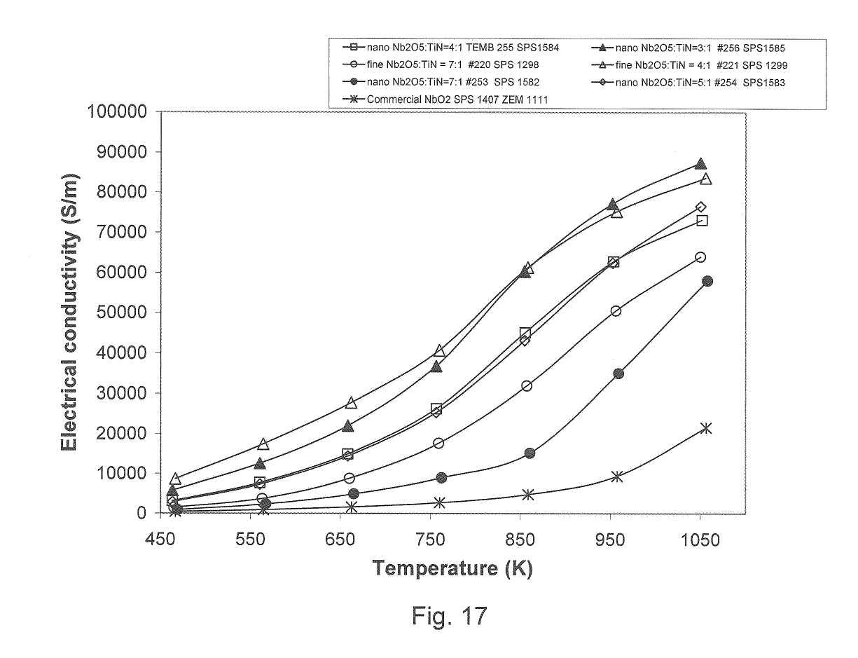

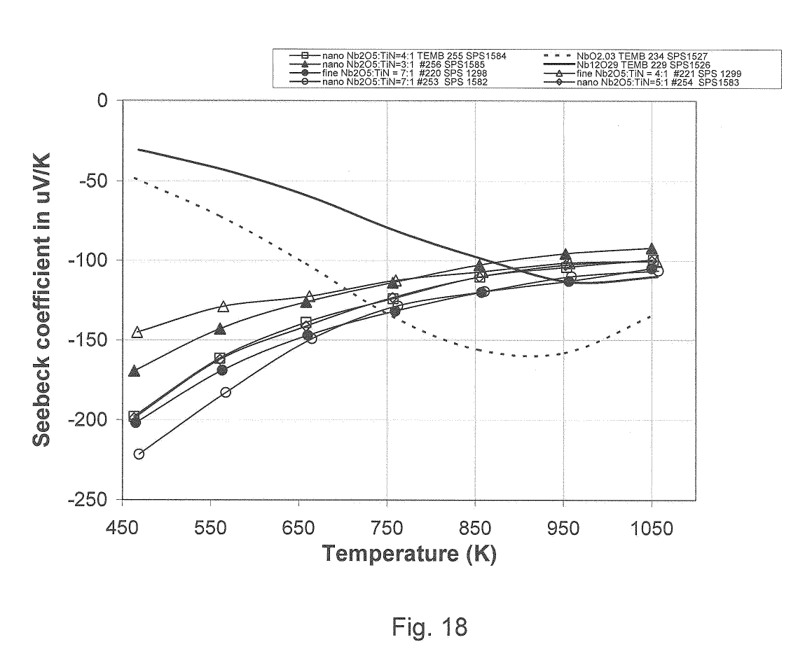

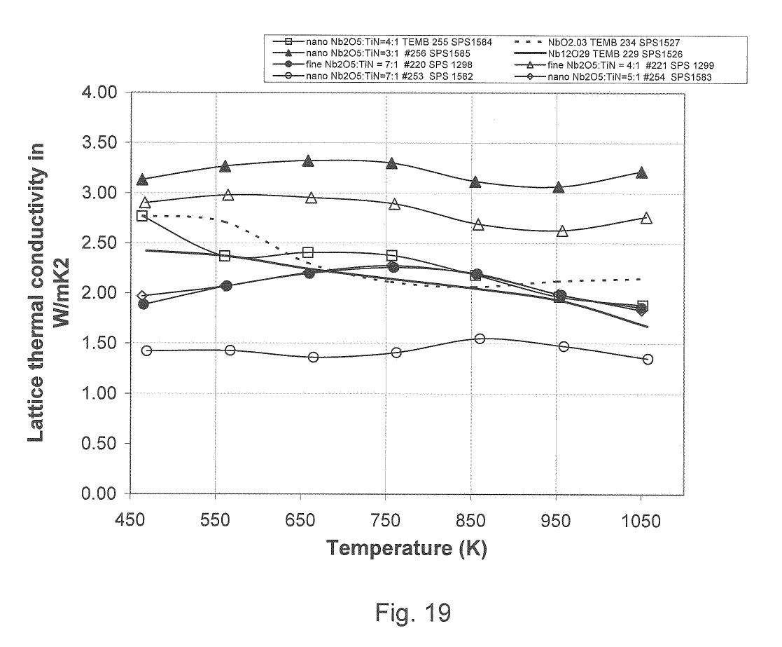

FIGS. 13-16 are plots versus temperature of the electrical conductivity, Seebeck coefficient, lattice conductivity and ZT values, respectively, for composite niobium oxide materials that include various carbide second phases. FIGS. 17-20 are a similar series of plots for composite niobium oxide materials that include various nitride second phases. The preparation and characterization of many samples summarized in FIGS. 9-20 was discussed previously in reference to Tables 1 and 2. In FIGS. 18 and 19, example data for select inventive non-composite niobium oxide materials is included for reference.

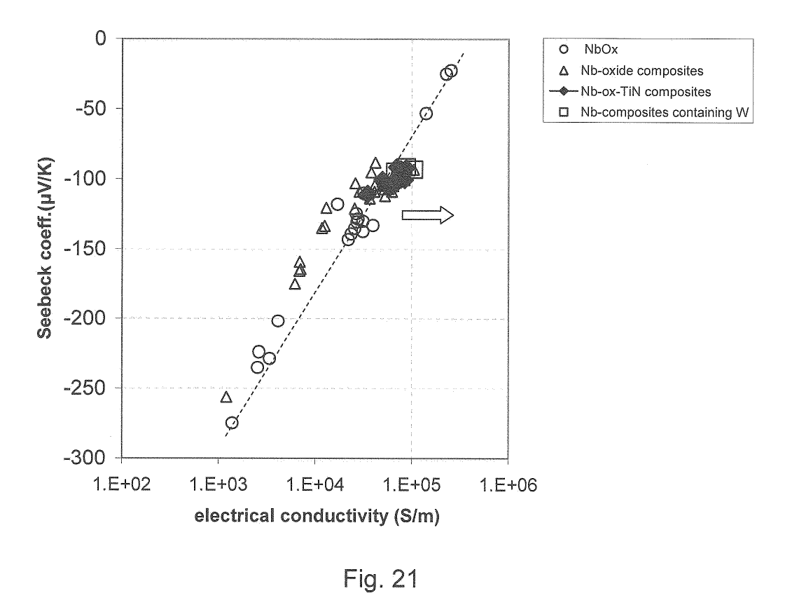

FIG. 21 is a plot of Seebeck coefficient as function of electrical conductivity at about 1000K for different niobium oxide-containing materials. The pure niobium oxide materials with different niobium to oxygen ratio align on a straight (dotted) line. It is desirable for the plotted data for improved thermoelectric properties to be on the right side of the dotted line (indicated by arrow). Composites with NbC or TiC are either on the line or shifted to lower Seebeck coefficient at similar conductivity (left of the dotted line). On the other hand, composites with TiN are shifted to higher Seebeck coefficient at a given conductivity, thus showing an advantage. For example, the TiN-containing composite materials exhibit a Seebeck coefficient of −100 μV/K at an electrical conductivity of about 1×10⁵ S/m. Niobium composites with low tungsten oxide levels show the same trend.

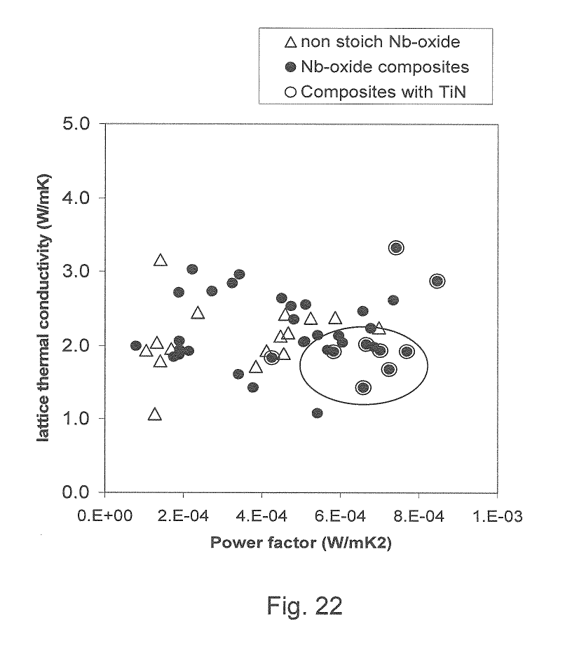

FIG. 22 is a plot of lattice thermal conductivity as function of power factor at about 1000K for various niobium oxide containing materials. The circled region represents an advantageous combination of high power factor at low thermal conductivity. The data are for niobium oxides, niobium oxide composites with TiC or NbC, and niobium oxide composites with TiN. The niobium oxide composites with TiN demonstrate advantageous properties. Another advantageous composition family can be identified from Table 2. The composites made from batch materials niobium oxide, titanium nitride and tungsten oxide excel in their power factors and are also located in the same advantageous sector of high power factor and low thermal conductivity due to the presence of a mixed nitride dispersion and a dispersion of small tungsten metal particles.

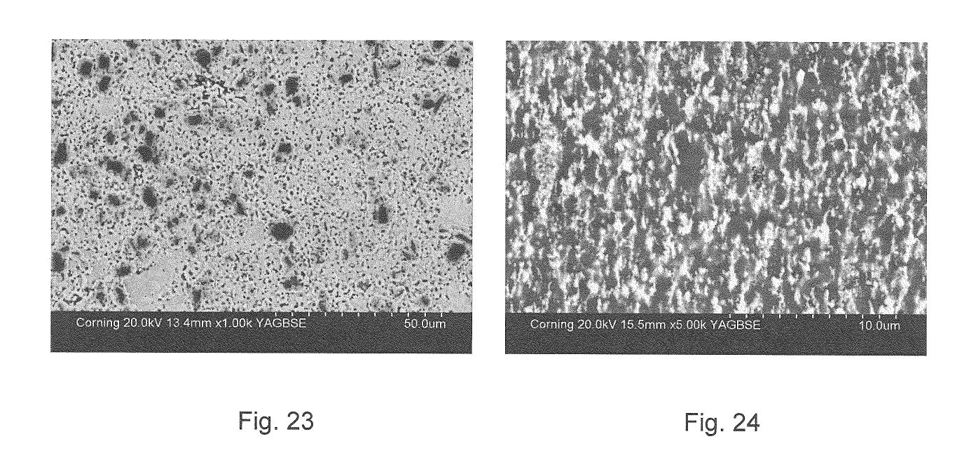

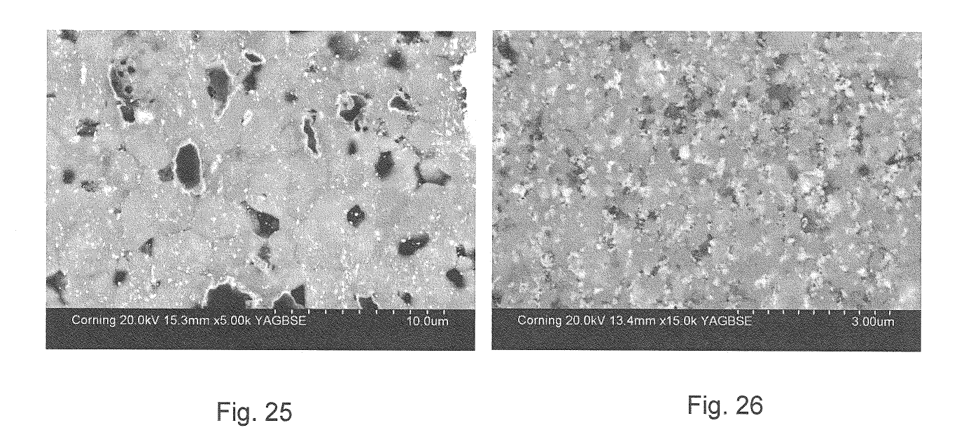

Scanning Electron Microscope (SEM) images of select sample microstructures are shown in FIGS. 23-26. FIG. 23 is a micrograph of an example composite material comprising niobium oxide and TiN (n-Nb₂O₅:TiN=7:1). FIG. 24 is a micrograph of an example composite material comprising niobium oxide and TiC (n-TiO₂:Nb₂O₅:TiC=3:1:1). FIG. 25 is a micrograph of a further example composite material comprising niobium oxide and TiN (n-Nb₂O₅:n-tungsten oxide:TiN=20:2:5). FIG. 26 is a micrograph of a further example composite material comprising niobium oxide and TiC (Nb₂O₅:tungsten oxide:TiC=20:2:5).

Disclosed are thermoelectric materials having a very low lattice thermal conductivity. Crystallographic shear defects and especially complex block structures retained within these materials provide a new approach for tuning the thermal conductivity of thermoelectric oxide materials with a phonon scattering length on the order to 0.5 to 5 nanometers. Also disclosed are processes for forming such materials that involve, for example, reductive densification, where a starting niobium oxide powder or composite is prepared and then densified rapidly under high pressure in the presence of a reducing agent or by a solid state reduction.

As used herein, the singular forms “a,” “an” and “the” include plural referents unless the context clearly dictates otherwise. Thus, for example, reference to “an oxide” includes examples having two or more such “oxides” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made to the present invention without departing from the spirit and scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A thermoelectric oxide material comprising periodic planar crystallographic defects, wherein the planar defects have a plane-to-plane spacing of 0.5 to 5 nm.

2. The thermoelectric oxide material according to claim 1, wherein the plane-to-plane spacing varies within the material over a range of 0.5 to 5 nm.

3. The thermoelectric oxide material according to claim 1, comprising two families of intersecting periodic planar crystallographic defect planes, wherein each family of planar defects has a plane-to-plane spacing of 0.5 to 5 nm.

4. The thermoelectric oxide material according to claim 1, wherein the plane-to-plane spacing coincides with a mean free path of phonons in the oxide material.

5. The thermoelectric oxide material according to claim 1, wherein the plane-to-plane periodicity ranges from about 1 to 2 nm.

6. The thermoelectric oxide material according to claim 1, wherein a thermoelectric figure of merit for the material at 1050K is greater than 0.15.

7. The thermoelectric oxide material according to claim 1, wherein a lattice thermal conductivity of the material is less than 3 W/mK over a temperature range of 450 to 1050K.

8. The thermoelectric oxide material according to claim 1, wherein the Seebeck coefficient for the material at 1050K is more negative than −80 μV/K.

9. The thermoelectric oxide material according to claim 1, wherein an electrical conductivity of the material is greater than 2000 S/m over a temperature range of 450-1050K.

10. A sub-stoichiometric, composite thermoelectric oxide material represented by the formula NbO_{2.5-x}:M, where 0<x≦1.5 and M represents a second phase.

11. The thermoelectric oxide material according to claim 10, wherein 0.3≦x≦0.7.

12. The thermoelectric oxide material according to claim 10, wherein the second phase is selected from the group consisting of carbon, Nb, W, Mo, NbO, TiO₂, TiC, TiN, NbC, ZnO, Cu, WC and mixtures thereof.

13. The thermoelectric oxide material according to claim 10, wherein the second phase comprises 1 to 30 wt. % of the material.

14. The thermoelectric oxide material according to claim 10, further comprising at least one dopant selected from the group consisting of W, Mo, Ti, Ta, Zr, Ce, La and Y.

15. The thermoelectric oxide material according to claim 10, wherein a thermoelectric figure of merit for the material at 1050K is greater than 0.15.

16. The thermoelectric oxide material according to claim 10, wherein a lattice thermal conductivity of the material is less than 3 W/mK over a temperature range of 450 to 1050K.

17. The thermoelectric oxide material according to claim 10, wherein an electrical conductivity of the material is greater than 2000 S/m and a Seebeck coefficient more negative than −80 μV/K over a temperature range of 450 to 1050K.

18. The thermoelectric oxide material according to claim 10, wherein the thermoelectric oxide material comprises one or more families of shear defect planes.

19. A thermoelectric device comprising the thermoelectric oxide material according to claim 10.

20. A method of making sub-stoichiometric, composite thermoelectric oxide material represented by the formula NbO_{2.5-x}:M, where 0<x≦1.5 and M represents a second phase, comprising:
combining niobium oxide powder and a second phase powder to form a mixture; and
heating the mixture at a reaction temperature of at least 900° C. to form a sub-stoichiometric, composite material.

21. The method according to claim 20, wherein the niobium oxide powder and the second phase powder are dispersed in a liquid and mixed ultrasonically to form the mixture.

22. The method according to claim 20, wherein the mixture is heated in a reducing environment, said reducing environment comprising at least one of exposure of the mixture to a solid state reducing agent selected from the group consisting of elemental carbon, carbide, nitride, boride, metal or suboxide, or exposure of the mixture to a reducing gas mixture selected from the group consisting of H₂/H₂O, CO/CO₂ and C/CO.

23. The method according to claim 22, wherein the carbide is selected from the group consisting of titanium carbide, niobium carbide and tungsten carbide, and the nitride is selected from the group consisting of titanium nitride and tungsten nitride.

24. The method according to claim 20, wherein an average particle size of the niobium oxide powder is from 20 nanometers to 100 micrometers.

25. The method according to claim 20, further comprising densifying the sub-stoichiometric, composite material via spark plasma sintering.
